(19) United States
(12) Patent Application Publication
(10) Pub. No.: US 2019/0205862 A1
(43) Pub. Date: Jul. 4, 2019

(54) Payment Method, Payment Terminal, and Substitute Payment Server

(71) Applicant: Huawei Technologies Co., Ltd., Shenzhen, Guangdong (CN)

(72) Inventors: Tiansong Xu, Nanjing (CN); Mingxing Cai, Nanjing (CN)

(21) Appl. No.: 16/311,511

(22) PCT Filed: Jun. 21, 2017
(86) PCT No.: PCT/CN2017/089412

§ 371 Date: Dec. 19, 2018

(30) Foreign Application Priority Data
Jun. 24, 2016 (CN) 201610488300.8

(51) Int. Cl. G06Q 20/22; G06Q 20/14; G06Q 30/02; G06Q 20/32; G06Q 20/04

(52) U.S. Cl. CPC G06Q 20/29; G06Q 20/14; G06Q 20/0453; G06Q 20/322; G06Q 30/0277

(57) ABSTRACT

A payment method includes obtaining, by a payment terminal, order information, where the order information includes at least a total payment amount, receiving a substitute payment instruction, determining information about at least two substitute payers and a substitute payment amount of each substitute payer based on the substitute payment instruction, and sending a substitute payment request message to a substitute payment server, where the substitute payment request message includes information about each substitute payer and the substitute payment amount of each substitute payer, and the substitute payment request message requesting the substitute payment server to generate a payment link corresponding to the substitute payment amount of each substitute payer and send the payment link corresponding to the substitute payment amount of each substitute payer to a corresponding substitute payment terminal to enable the at least two substitute payers to perform substitute payment.

This application claims priority to Chinese Patent Application No. 201610488300.8, filed with the Chinese Patent Office on Jun. 24, 2016 and entitled “PAYMENT METHOD, PAYMENT TERMINAL, AND SUBSTITUTE PAYMENT SERVER”, which is incorporated herein by reference in its entirety.

### TECHNICAL FIELD

The present invention relates to the field of payment technologies, and in particular, to a payment method, a payment terminal, and a substitute payment server.

### BACKGROUND

With popularity of mobile payment, more and more users choose mobile payment during shopping. When a balance in an account of a user is insufficient, the user may need to ask another person to perform substitute payment. Currently, some payment clients support a function of substitute payment by others. If the user chooses to use a payment client having the function of substitute payment by others to perform online shopping, when settling an order, the user may select a substitute payer to perform substitute payment. Specifically, when settling the order, the user selects a user name of a friend from a friend list corresponding to the payment client, or the user directly enters an account or a user name of a friend, and then inputs an instruction “ask him/her to perform substitute payment”. Then a payment terminal of the user can generate a substitute payment request corresponding to the order, and send the substitute payment request to the friend. The friend can view the substitute payment request after logging in to the payment client, and the friend can settle the order for the user according to the substitute payment request.

However, in the existing function of substitute payment by others, every time the user can select only one substitute payer to perform substitute payment, and the substitute payer needs to perform substitute payment of a full amount. Therefore, when the substitute payment request corresponds to a relatively large substitute payment amount, the substitute payer may be incapable of completing substitute payment, resulting in a failure in a current bill transaction.

### SUMMARY

Embodiments of the present invention provide a payment method, a payment terminal, and a substitute payment server, so that a plurality of persons can pay for a same order, thereby increasing a bill transaction success rate.

The following technical solutions are used in the embodiments of the present invention to achieve the foregoing objective.

According to a first aspect, an embodiment of the present invention provides a payment method. The method includes: obtaining, by a payment terminal, order information, where the order information includes at least a total payment amount; receiving, by the payment terminal, a substitute payment instruction, and determining information about at least two substitute payers and a substitute payment amount of each of the at least two substitute payers based on the received substitute payment instruction, where a sum of substitute payment amounts of the at least two substitute payers is less than or equal to the total payment amount, that is, the payment terminal may allocate all of the total payment amount to the at least two substitute payers, or may allocate a part of the total payment amount to the at least two substitute payers; and sending, by the payment terminal, a substitute payment request message to a substitute payment server, where the substitute payment request message includes information about each substitute payer and the substitute payment amount of each substitute payer, and the substitute payment request message is used to request the substitute payment server to generate a payment link corresponding to the substitute payment amount of each substitute payer and send, based on the information about each substitute payer, the payment link corresponding to the substitute payment amount of each substitute payer to a corresponding substitute payment terminal.

In the payment method provided in this embodiment of the present invention, the payment terminal may obtain the information about the at least two substitute payers, and divide the total payment amount to determine the substitute payment amount of each of the at least two substitute payers. The information about each substitute payer and the substitute payment amount of each substitute payer are carried in the substitute payment request message and sent to the substitute payment server. The substitute payment server generates the payment link corresponding to the substitute payment amount of each substitute payer, and sends each payment link to the corresponding substitute payment terminal, so that the at least two substitute payers pay amounts requiring substitute payment of the at least two substitute payers. By using the payment method, the at least two substitute payers can perform substitute payment for a same order, and each substitute payer needs to perform substitute payment of only a part of a total payment amount of the order, thereby reducing a substitute payment amount of the substitute payer, and increasing a bill transaction success rate.

Optionally, the substitute payment instruction includes a substitute payment triggering instruction and a selection instruction, the information about the at least two substitute payers includes contact information of each substitute payer; and the determining, by the payment terminal, information about at least two substitute payers based on the substitute payment instruction includes:

reading and displaying, by the payment terminal based on the substitute payment triggering instruction, a contact list stored on the payment terminal; and determining, by the payment terminal based on the selection instruction, contact information of the at least two substitute payers that are selected by a user from the contact list.

In the foregoing optional manner, the user may directly select the at least two substitute payers from the contact list displayed on the payment terminal, and the payment terminal obtains the contact information, stored in the contact list, of the at least two substitute payers, without requiring the user's manual entry.

Optionally, the substitute payment instruction includes the substitute payment amount of each substitute payer, and the determining, by the payment terminal, a substitute payment amount of each of the at least two substitute payers based on the substitute payment instruction includes:

dividing, by the payment terminal, the total payment amount based on the received substitute payment amount of each substitute payer, to determine the substitute payment amount of each substitute payer.

In the foregoing optional manner, the user may allocate the substitute payment amount of each substitute payer as the user wants, so that substitute payment in this embodiment of the present invention is more flexible.

Optionally, the substitute payment instruction includes a random allocation instruction; and the determining, by the payment terminal, a substitute payment amount of each of the at least two substitute payers based on the substitute payment instruction includes:

determining, by the payment terminal, a quantity of the at least two substitute payers based on the random allocation instruction that is input by the user; randomly allocating the substitute payment amount of each substitute payer based on the total payment amount and the quantity of the at least two substitute payers, to obtain a random allocation result of the total payment amount; and dividing the total payment amount based on the random allocation result, to determine the substitute payment amount of each substitute payer.

Optionally, after the determining, by the payment terminal, a substitute payment amount of each of the at least two substitute payers based on the substitute payment instruction, the method further includes:

calculating, by the payment terminal, a payment amount of the user based on the total payment amount and the sum of the substitute payment amounts of the at least two substitute payers; and paying, by the payment terminal, the payment amount of the user by using a payment gateway, where the substitute payment request message further includes the payment amount of the user and an identifier of the user.

Optionally, the payment terminal may alternatively obtain information about one substitute payer, and determine a substitute payment amount of the substitute payer and a payment amount of the user. The substitute payment amount of the substitute payer is less than the total payment amount.

In the foregoing optional manner, when the user requests another person to perform substitute payment, the user may also pay a part of the amount, to reduce the substitute payment amount of the substitute payer.

According to a second aspect, an embodiment of the present invention provides a payment method. The method includes:

receiving, by a substitute payment server, a substitute payment request message sent by a payment terminal, where the substitute payment request message includes information about at least two substitute payers and a substitute payment amount of each of the at least two substitute payers, and a sum of substitute payment amounts of the at least two substitute payers is less than or equal to the total payment amount, that is, the payment terminal may allocate all of the total payment amount to the at least two substitute payers, or may allocate a part of the total payment amount to the at least two substitute payers; generating, by the substitute payment server, a corresponding payment link based on the substitute payment amount of each substitute payer; and sending, by the substitute payment server, the corresponding payment link to a corresponding substitute payment terminal based on information about each substitute payer, so that the corresponding substitute payment terminal pays a substitute payment amount of a corresponding substitute payer based on the corresponding payment link by using a payment gateway.

In the payment method provided in this embodiment of the present invention, the substitute payment server can receive the substitute payment request message sent by the payment terminal, generate, based on the substitute payment amount of each of the at least two substitute payers that is carried in the substitute payment request message, the payment link corresponding to the substitute payment amount of the substitute payer, and send the payment link to the substitute payment terminal, so that the substitute payer pays the substitute payment amount of the substitute payer. By using the payment method, the at least two substitute payers can perform substitute payment for a same order, and each substitute payer needs to perform substitute payment of only a part of a total payment amount of the order, thereby reducing a substitute payment amount of the substitute payer, and increasing a bill transaction success rate.

Optionally, the information about each substitute payer includes contact information of the corresponding substitute payer, and the sending, by the substitute payment server, the corresponding payment link to a corresponding substitute payment terminal based on information about each substitute payer includes:

sending, by the substitute payment server, the corresponding payment link to the corresponding substitute payment terminal based on contact information of each substitute payer, where the corresponding substitute payment terminal runs an application program corresponding to the contact information of the corresponding substitute payer.

Optionally, the substitute payment request message further includes a first order number and merchant information; and the information about each substitute payer further includes an identifier of the corresponding substitute payer.

Optionally, after the sending, by the substitute payment server, the corresponding payment link to a corresponding substitute payment terminal based on information about each substitute payer, the method further includes:

receiving, by the substitute payment server, a payment acknowledgment message sent by the payment gateway, where the payment acknowledgment message includes an identifier of a payer and a second order number; and if the substitute payment server determines that the identifier of the payer is the same as an identifier of one of the at least two substitute payers, and the second order number is the same as the first order number, determining, by the substitute payment server, that the substitute payer completes payment of a substitute payment amount of the substitute payer.

Optionally, when the total payment amount is subject only to substitute payment of the substitute payers, the method further includes:

after the substitute payment server determines that each of the at least two substitute payers completes payment, summarizing, by the substitute payment server, substitute payment amounts of all the at least two substitute payers, and generating a payment feedback message; and sending, by the substitute payment server, the payment feedback message to a payee terminal based on the merchant information.

Optionally, when the total payment amount is jointly paid by the substitute payers and a user, the substitute payment request message further includes a payment amount of the user and an identifier of the user, and the method further includes: after the substitute payment server determines that each of the at least two substitute payers and the user completes payment, summarizing, by the substitute payment server, substitute payment amounts of all the at least two substitute payers and the payment amount of the user, and generating a payment feedback message; and sending, by the substitute payment server, the payment feedback message to a payee terminal based on the merchant information.

According to a third aspect, an embodiment of the present invention provides a payment method. The method includes:

obtaining, by a payment terminal, order information, where the order information includes at least a total payment amount; receiving, by the payment terminal, a substitute payment instruction, and determining information about a substitute payer, a substitute payment amount of the substitute payer, and a payment amount of a user based on the substitute payment instruction, where the substitute payment amount of the substitute payer is less than the payment amount of the user; sending, by the payment terminal, a substitute payment request message to a substitute payment server, where the substitute payment request message includes the information about the substitute payer and the substitute payment amount of the substitute payer, and the substitute payment request message is used to request the substitute payment server to generate a payment link corresponding to the substitute payment amount of the substitute payer and send the payment link to a corresponding substitute payment terminal based on the information about the substitute payer; and paying, by the payment terminal, the payment amount of the user by using a payment gateway.

In the payment method provided in this embodiment of the present invention, the payment terminal may determine the information about the substitute payer, and divide the total payment amount to determine the substitute payment amount of the substitute payer and the payment amount of the user. The user pays the payment amount of the user. The information about the substitute payer and the substitute payment amount of the substitute payer are carried in the substitute payment request message and sent to the substitute payment server. The substitute payment server generates the payment link corresponding to the substitute payment amount of the substitute payer, and sends the payment link to the corresponding substitute payment terminal, so that the at least two substitute payers pay amounts requiring substitute payment of the at least two substitute payers. By using the payment method, the user and the substitute payer can pay for a same order, and the substitute payer needs to perform substitute payment of only a part of a total payment amount of the order, thereby reducing the substitute payment amount of the substitute payer, and increasing a bill transaction success rate.

Optionally, the substitute payment instruction includes a substitute payment triggering instruction and a selection instruction, the information about the substitute payer includes contact information of the substitute payer, and the determining, by the payment terminal, information about a substitute payer based on the substitute payment instruction includes:

reading and displaying, by the payment terminal based on the substitute payment triggering instruction, a contact list stored on the payment terminal; and determining, by the payment terminal based on the selection instruction, the contact information of the substitute payer that is selected by the user from the contact list.

Optionally, the substitute payment instruction includes the substitute payment amount of the substitute payer, and the determining, by the payment terminal, a substitute payment amount of the substitute payer and a payment amount of a user based on the substitute payment instruction includes:

determining, by the payment terminal, the substitute payment amount of the substitute payer based on the received substitute payment amount of the substitute payer; and calculating, by the payment terminal, the payment amount of the user based on the total payment amount and the substitute payment amount of the substitute payer.

In the foregoing optional manner, the user may allocate the substitute payment amount of the substitute payer and the payment amount of the user as the user wants, so that substitute payment in this embodiment of the present invention is more flexible.

Optionally, the substitute payment instruction includes a random allocation instruction; and the determining, by the payment terminal, a substitute payment amount of the substitute payer and a payment amount of a user based on the substitute payment instruction includes:

randomly allocating, by the payment terminal, the substitute payment amount of the substitute payer and the payment amount of the user based on the received random allocation instruction, to obtain a random allocation result of the total payment amount, and determining the substitute payment amount of the substitute payer and the payment amount of the user based on the random allocation result.

Optionally, the order information further includes a first order number and merchant information; the substitute payment request message further includes the first order number, the merchant information, the payment amount of the user, and an identifier of the user; and the information about the substitute payer further includes an identifier of the substitute payer.

According to a fourth aspect, an embodiment of the present invention provides a payment method. The method includes:

receiving, by a substitute payment server, a substitute payment request message sent by a payment terminal, where the substitute payment request message includes information about a substitute payer and a substitute payment amount of the substitute payer, and the substitute payment amount of the substitute payer is less than a total payment amount; generating, by the substitute payment server, a payment link based on the substitute payment amount of the substitute payer; and sending, by the substitute payment server, the payment link to a corresponding substitute payment terminal based on the information about the substitute payer, so that the substitute payment terminal pays the substitute payment amount of the substitute payer based on the payment link by using a payment gateway.

In the payment method provided in this embodiment of the present invention, the substitute payment server can receive the substitute payment request message sent by the payment terminal, generate, based on the substitute payment amount of the substitute payer that is carried in the substitute payment request message, the payment link corresponding to the substitute payment amount of the substitute payer, and send the payment link to the substitute payment terminal, so that the substitute payer pays the substitute payment amount of the substitute payer. By using the payment method, a user and the substitute payer can pay for a same order, and the substitute payer needs to perform substitute payment of only a part of a total payment amount of the order, thereby reducing the substitute payment amount of the substitute payer, and increasing a bill transaction success rate.

Optionally, the information about the substitute payer includes contact information of the substitute payer, and the sending, by the substitute payment server, the payment link to a corresponding substitute payment terminal based on the information about the substitute payer includes:

sending, by the substitute payment server, the payment link to the corresponding substitute payment terminal based on the contact information of the substitute payer, where the substitute payment terminal runs an application program corresponding to the contact information of the substitute payer.

Optionally, the substitute payment request message further includes a first order number and merchant information; and the information about the substitute payer further includes an identifier of the substitute payer.

Optionally, after the sending, by the substitute payment server, the payment link to a corresponding substitute payment terminal based on the information about the substitute payer, the method further includes:

receiving, by the substitute payment server, a payment acknowledgment message sent by the payment gateway, where the payment acknowledgment message includes an identifier of a payer and a second order number; and if the substitute payment server determines that the identifier of the payer is the same as the identifier of the substitute payer, and the second order number is the same as the first order number, determining, by the substitute payment server, that the substitute payer completes payment of the substitute payment amount of the substitute payer.

Optionally, the substitute payment request message further includes a payment amount of a user and an identifier of the user, and the method further includes:

after the substitute payment server determines that each of the substitute payer and the user completes payment, summarizing, by the substitute payment server, the substitute payment amount of the substitute payer and the payment amount of the user, and generating a payment feedback message, where the payment feedback message is used to indicate that payment of the total payment amount corresponding to the first order number is completed; and sending, by the substitute payment server, the payment feedback message to a payee terminal based on the merchant information.

According to a fifth aspect, an embodiment of the present invention provides a payment terminal. The payment terminal includes:

an obtaining unit, configured to obtain order information, where the order information includes at least a total payment amount;

a determining unit, configured to receive a substitute payment instruction, and determine information about at least two substitute payers and a substitute payment amount of each of the at least two substitute payers based on the substitute payment instruction, where a sum of substitute payment amounts of the at least two substitute payers is less than or equal to the total payment amount; and

a sending unit, configured to send a substitute payment request message to a substitute payment server, where the substitute payment request message includes information about each substitute payer and the substitute payment amount of each substitute payer that are determined by the determining unit, and the substitute payment request message is used to request the substitute payment server to generate at least two payment links respectively corresponding to the substitute payment amounts of all the substitute payers and respectively send the at least two payment links to corresponding substitute payment terminals, so that the at least two substitute payers perform substitute payment.

By using the payment terminal provided in this embodiment of the present invention, the at least two substitute payers can perform substitute payment for a same order, and each substitute payer needs to perform substitute payment of only a part of a total payment amount of the order, thereby reducing a substitute payment amount of the substitute payer, and increasing a bill transaction success rate.

Optionally, the substitute payment instruction includes a substitute payment triggering instruction and a selection instruction, the information about the at least two substitute payers includes contact information of each substitute payer; and the determining unit is specifically configured to read and display, based on the substitute payment triggering instruction, a contact list stored on the payment terminal, and determine, based on the selection instruction, contact information of the at least two substitute payers that are selected by a user from the contact list.

Optionally, the substitute payment instruction includes the substitute payment amount of each substitute payer, and the determining unit is specifically configured to determine the substitute payment amount of each substitute payer based on the substitute payment amount, entered by the user, of each substitute payer.

Optionally, the substitute payment instruction includes a random allocation instruction. The determining unit is specifically configured to determine a quantity of the at least two substitute payers based on the received random allocation instruction; randomly allocate the substitute payment amount of each substitute payer based on the total payment amount and the quantity of the at least two substitute payers, to obtain a random allocation result of the total payment amount; and divide the total payment amount based on the random allocation result, to determine the substitute payment amount of each substitute payer.

Optionally, the payment terminal further includes a payment unit. The determining unit is further configured to: after dividing the total payment amount to determine the substitute payment amount of each of the at least two substitute payers, calculate a payment amount of the user based on the total payment amount and the sum of the substitute payment amounts of the at least two substitute payers; and the payment unit is configured to pay the payment amount of the user by using a payment gateway, where

the substitute payment request message further includes the payment amount of the user and an identifier of the user.

For technical effects of the payment terminal provided in this embodiment of the present invention, refer to the technical effects of the payment method in the first aspect and the optional manners of the first aspect, and details are not described herein again.

According to a sixth aspect, an embodiment of the present invention provides a substitute payment server. The substitute payment server includes:

a receiving unit, configured to receive a substitute payment request message sent by a payment terminal, where the substitute payment request message includes information about at least two substitute payers and a substitute payment amount of each of the at least two substitute payers; a generation unit, configured to generate a corresponding payment link based on the substitute payment amount, received by the receiving unit, of each substitute payer; and a sending unit, configured to send the corresponding payment link to a corresponding substitute payment terminal based on information that is received by the receiving unit and that is about each substitute payer, so that the corresponding substitute payment terminal pays a substitute payment amount of a corresponding substitute payer based on the corresponding payment link by using a payment gateway.

Through the substitute payment server provided in this embodiment of the present invention, the at least two substitute payers can perform substitute payment for a same order, and each substitute payer needs to perform substitute payment of only a part of a total payment amount of the order, thereby reducing a substitute payment amount of the substitute payer, and increasing a bill transaction success rate.

Optionally, the information about each substitute payer includes contact information of the corresponding substitute payer, and the sending unit is specifically configured to send the corresponding payment link to the corresponding substitute payment terminal based on contact information of each substitute payer, where the corresponding substitute payment terminal runs an application program corresponding to the contact information of the corresponding substitute payer.

Optionally, the substitute payment server further includes a determining unit. The receiving unit is further configured to: after the sending unit sends the corresponding payment link to the corresponding substitute payment terminal based on the information about each substitute payer, receive a payment acknowledgment message sent by the payment gateway, where the payment acknowledgment message includes an identifier of a payer and a second order number; and the determining unit is configured to: if determining that the identifier of the payer is the same as the identifier of the substitute payer, and the second order number is the same as the first order number, determine that the substitute payer completes payment of the substitute payment amount of the substitute payer.

Optionally, the substitute payment server further includes a summarization unit. The summarization unit is configured to: after the determining unit determines that each of the at least two substitute payers completes payment, summarize substitute payment amounts of the at least two substitute payers, and generate a payment feedback message; and the sending unit is further configured to send the payment feedback message to a payee terminal based on the merchant information.

Optionally, the substitute payment request message further includes a payment amount of the user and an identifier of the user. The summarization unit is configured to: after the determining unit determines that each of the at least two substitute payers and the user completes payment, summarize substitute payment amounts of the at least two substitute payers and the payment amount of the user, and generate a payment feedback message; and the sending unit is further configured to send the payment feedback message to a payee terminal based on the merchant information.

For technical effects of the substitute payment server provided in this embodiment of the present invention, refer to the technical effects of the payment method in the second aspect and the optional manners of the second aspect, and details are not described herein again.

In the first aspect and the fifth aspect, the order information and the substitute payment request message further include the first order number and the merchant information; and the information about the at least two substitute payers further includes an identifier of each substitute payer.

In the second aspect and the sixth aspect, the payment feedback message is used to indicate that payment of the total payment amount corresponding to the first order number is completed.

According to a seventh aspect, an embodiment of the present invention provides a payment terminal, including:

an obtaining unit, configured to obtain order information, where the order information includes at least a total payment amount; a determining unit, configured to receive a substitute payment instruction, and determine information about a substitute payer, a substitute payment amount of the substitute payer, and a payment amount of a user based on the substitute payment instruction, where the substitute payment amount of the substitute payer is less than the total payment amount; a sending unit, configured to send a substitute payment request message to a substitute payment server, where the substitute payment request message includes the information about the substitute payer and the substitute payment amount of the substitute payer, and the substitute payment request message is used to request the substitute payment server to generate a payment link corresponding to the substitute payment amount of the substitute payer and send the payment link to a corresponding substitute payment terminal based on the information about the substitute payer; and a payment unit, configured to pay the payment amount of the user by using a payment gateway.

Optionally, the substitute payment instruction includes a substitute payment triggering instruction and a selection instruction, the information about the substitute payer includes contact information of the substitute payer, and the determining unit is specifically configured to read and display, based on the substitute payment triggering instruction, a contact list stored on the payment terminal, and determine, based on the selection instruction, the contact information of the substitute payer that is selected by the user from the contact list.

Optionally, the substitute payment instruction includes the substitute payment amount of the substitute payer, and the determining unit is specifically configured to determine the substitute payment amount of the substitute payer based on the received substitute payment amount of the substitute payer, and calculate the payment amount of the user based on the total payment amount and the substitute payment amount of the substitute payer.

Optionally, the substitute payment instruction includes a random allocation instruction. The determining unit is specifically configured to randomly allocate the substitute payment amount of the substitute payer and the payment amount of the user based on the received random allocation instruction, to obtain a random allocation result of the total payment amount, and determine the substitute payment amount of the substitute payer and the payment amount of the user based on the random allocation result.

Optionally, the order information obtained by the obtaining unit further includes a first order number and merchant information; the substitute payment request message sent by the sending unit further includes the first order number, the merchant information, the payment amount of the user, and an identifier of the user; and the information that is determined by the determining unit and that is about the substitute payer further includes an identifier of the substitute payer.

According to an eighth aspect, an embodiment of the present invention provides a substitute payment server, including:

a receiving unit, configured to receive a substitute payment request message sent by a payment terminal, where the substitute payment request message includes information about a substitute payer and a substitute payment amount of the substitute payer, and the substitute payment amount of the substitute payer is less than a total payment amount; a generation unit, configured to generate a payment link based on the substitute payment amount of the substitute payer; and a sending unit, configured to send the payment link to a corresponding substitute payment terminal based on the information about the substitute payer, so that the substitute payment terminal pays the substitute payment amount of the substitute payer based on the payment link by using a payment gateway.

Optionally, the information that is received by the receiving unit and that is about the substitute payer includes contact information of the substitute payer, and the sending unit is specifically configured to send the payment link to the corresponding substitute payment terminal based on the contact information of the substitute payer, where the substitute payment terminal runs an application program corresponding to the contact information of the substitute payer.

Optionally, the substitute payment request message received by the receiving unit further includes a first order number and merchant information; and the information about the substitute payer further includes an identifier of the substitute payer.

Optionally, the substitute payment server further includes a determining unit. The receiving unit is further configured to: after the sending unit sends the payment link to the corresponding substitute payment terminal based on the information about the substitute payer, receive a payment acknowledgment message sent by the payment gateway, where the payment acknowledgment message includes an identifier of a payer and a second order number; and the determining unit is configured to: if determining that the identifier of the payer is the same as the identifier of the substitute payer, and the second order number is the same as the first order number, determine, by the substitute payment server, that the substitute payer completes payment of the substitute payment amount of the substitute payer.

Optionally, the substitute payment request message received by the receiving unit further includes a payment amount of a user and an identifier of the user, and the substitute payment server further includes a summarization unit. The summarization unit is configured to: after the determining unit determines that each of the substitute payer and the user completes payment, summarize the substitute payment amount of the substitute payer and the payment amount of the user, and generate a payment feedback message, where the payment feedback message is used to indicate that payment of the total payment amount corresponding to the first order number is completed; and the sending unit is further configured to send the payment feedback message to a payee terminal based on the merchant information.

According to a ninth aspect, an embodiment of the present invention provides a payment terminal, including an input unit, a processor, and a radio frequency (English: Radio Frequency, RF) circuit. The input unit is configured to receive a substitute payment instruction; the processor is configured to obtain order information, and determine information about at least two substitute payers and a substitute payment amount of each of the at least two substitute payers based on the substitute payment instruction received by the input unit, where the order information includes at least a total payment amount, and a sum of substitute payment amounts of the at least two substitute payers is less than or equal to the total payment amount; and the RF circuit is configured to send a substitute payment request message to a substitute payment server, where the substitute payment request message includes information about each substitute payer and the substitute payment amount of each substitute payer that are determined by the processor, and the substitute payment request message is used to request the substitute payment server to generate a payment link corresponding to the substitute payment amount of each substitute payer and send, based on the information about each substitute payer, the payment link corresponding to the substitute payment amount of each substitute payer to a corresponding substitute payment terminal.

Optionally, the substitute payment instruction includes a substitute payment triggering instruction and a selection instruction, the information about the at least two substitute payers includes contact information of each substitute payer; and the determining, by the processor, information about at least two substitute payers based on the substitute payment instruction is specifically: reading and displaying, based on the substitute payment triggering instruction, a contact list stored on the payment terminal, and determining, based on the selection instruction, contact information of the at least two substitute payers that are selected by a user from the contact list.

Optionally, the substitute payment instruction includes the substitute payment amount of each substitute payer, and the determining, by the processor, a substitute payment amount of each substitute payer based on the substitute payment instruction is specifically: determining the substitute payment amount of each substitute payer based on the received substitute payment amount of each substitute payer.

Optionally, the substitute payment instruction includes a random allocation instruction. The determining, by the processor, a substitute payment amount of each substitute payer based on the substitute payment instruction is specifically: determining a quantity of the at least two substitute payers based on the received random allocation instruction; randomly allocating the substitute payment amount of each substitute payer based on the total payment amount and the quantity of the at least two substitute payers, to obtain a random allocation result of the total payment amount; and determining the substitute payment amount of each substitute payer based on the random allocation result.

Optionally, the order information and the substitute payment request message further include a first order number and merchant information; and the information about the at least two substitute payers further includes an identifier of each substitute payer.

Optionally, the processor is further configured to: after determining the substitute payment amount of each of the at least two substitute payers, calculate a payment amount of the user based on the total payment amount and the sum of the substitute payment amounts of the at least two substitute payers, and pay the payment amount of the user by using a payment gateway; and the substitute payment request message sent by the RF circuit further includes the payment amount of the user and an identifier of the user.

For technical effects of the payment terminal provided in this embodiment of the present invention, refer to the technical effects in the first aspect or the optional manners of the first aspect, and details are not described herein again.

According to a tenth aspect, an embodiment of the present invention provides a substitute payment server, including a transceiver and a processor. The transceiver is configured to receive a substitute payment request message sent by a payment terminal, where the substitute payment request message includes information about at least two substitute payers and a substitute payment amount of each of the at least two substitute payers; the processor is configured to generate a corresponding payment link based on the substitute payment amount, received by the transceiver, of each substitute payer; and the transceiver is further configured to send the corresponding payment link to a corresponding substitute payment terminal based on information about each substitute payer, so that the corresponding substitute payment terminal pays a substitute payment amount of a corresponding substitute payer based on the corresponding payment link by using a payment gateway.

Optionally, the information about each substitute payer includes contact information of the corresponding substitute payer, and the sending, by the transceiver, the corresponding payment link to a corresponding substitute payment terminal based on information about each substitute payer is specifically: sending the corresponding payment link to the corresponding substitute payment terminal based on contact information of each substitute payer, where the corresponding substitute payment terminal runs an application program corresponding to the contact information of the corresponding substitute payer.

Optionally, the substitute payment request message further includes a first order number and merchant information; and the information about each substitute payer further includes an identifier of the corresponding substitute payer.

Optionally, the transceiver is further configured to: after sending the corresponding payment link to the corresponding substitute payment terminal based on the information about each substitute payer, receive a payment acknowledgment message sent by the payment gateway, where the payment acknowledgment message includes an identifier of a payer and a second order number; and the processor is further configured to: if determining that the identifier of the payer is the same as an identifier of one of the at least two substitute payers, and the second order number is the same as the first order number, determine that the substitute payer completes payment of a substitute payment amount of the substitute payer.

Optionally, the processor is further configured to: after determining that each of the at least two substitute payers completes payment, summarize substitute payment amounts of the at least two substitute payers, and generate a payment feedback message, where the payment feedback message is used to indicate that payment of a total payment amount corresponding to the first order number is completed; and the transceiver is further configured to send the payment feedback message to a payee terminal based on the merchant information.

Optionally, the substitute payment request message further includes a payment amount of a user and an identifier of the user. The processor is further configured to: after determining that each of the at least two substitute payers and the user completes payment, summarize substitute payment amounts of the at least two substitute payers and the payment amount of the user, and generate a payment feedback message, where the payment feedback message is used to indicate that payment of a total payment amount corresponding to the first order number is completed; and the transceiver is further configured to send the payment feedback message to a payee terminal based on the merchant information.

For technical effects of the payment terminal provided in this embodiment of the present invention, refer to the technical effects in the second aspect or the optional manners of the second aspect, and details are not described herein again.

According to an eleventh aspect, an embodiment of the present invention provides a payment terminal, including an input unit, a processor, and an RF circuit. The input unit is configured to receive a substitute payment instruction; the processor is configured to obtain order information, determine information about a substitute payer, a substitute payment amount of the substitute payer, and a payment amount of a user based on the substitute payment instruction, and pay the payment amount of the user by using a payment gateway, where the order information includes at least a total payment amount, and the substitute payment amount of the substitute payer is less than the payment amount of the user; and the RF circuit is configured to send a substitute payment request message to a substitute payment server, where the substitute payment request message includes the information about the substitute payer and the substitute payment amount of the substitute payer, and the substitute payment request message is used to request the substitute payment server to generate a payment link corresponding to the substitute payment amount of the substitute payer and send the payment link to a corresponding substitute payment terminal based on the information about the substitute payer.

Optionally, the substitute payment instruction includes a substitute payment triggering instruction and a selection instruction, the information about the substitute payer includes contact information of the substitute payer, and the determining, by the processor, information about a substitute payer based on the substitute payment instruction is specifically: reading and displaying, based on the substitute payment triggering instruction, a contact list stored on the payment terminal, and determining, based on the selection instruction, the contact information of the substitute payer that is selected by the user from the contact list.

Optionally, the substitute payment instruction includes the substitute payment amount of the substitute payer, and the determining, by the processor, a substitute payment amount of the substitute payer and a payment amount of a user based on the substitute payment instruction is specifically: determining the substitute payment amount of the substitute payer based on the received substitute payment amount of the substitute payer, and calculating the payment amount of the user based on the total payment amount and the substitute payment amount of the substitute payer.

Optionally, the substitute payment instruction includes a random allocation instruction. The determining, by the processor, a substitute payment amount of the substitute payer and a payment amount of a user based on the substitute payment instruction is specifically: randomly allocating the substitute payment amount of the substitute payer and the payment amount of the user based on the received random allocation instruction, to obtain a random allocation result of the total payment amount, and dividing the total payment amount based on the random allocation result, to determine the substitute payment amount of the substitute payer and the payment amount of the user.

Optionally, the order information further includes a first order number and merchant information; the substitute payment request message further includes the first order number, the merchant information, the payment amount of the user, and an identifier of the user; and the information about the substitute payer further includes an identifier of the substitute payer.

For technical effects of the payment terminal provided in this embodiment of the present invention, refer to the technical effects in the third aspect or the optional manners of the third aspect, and details are not described herein again.

According to a twelfth aspect, an embodiment of the present invention provides a substitute payment server, including a processor and a transceiver. The transceiver is configured to receive a substitute payment request message sent by a payment terminal, where the substitute payment request message includes information about a substitute payer and a substitute payment amount of the substitute payer, and the substitute payment amount of the substitute payer is less than a total payment amount; the processor is configured to generate a payment link based on the substitute payment amount of the substitute payer; and the transceiver is further configured to send the payment link to a corresponding substitute payment terminal based on the information about the substitute payer, so that the substitute payment terminal pays the substitute payment amount of the substitute payer based on the payment link by using a payment gateway.

Optionally, the information about the substitute payer includes contact information of the substitute payer, and the sending, by the transceiver, the payment link to a corresponding substitute payment terminal based on the information about the substitute payer is specifically: sending the payment link to the corresponding substitute payment terminal based on the contact information of the substitute payer, where the substitute payment terminal runs an application program corresponding to the contact information of the substitute payer.

Optionally, the substitute payment request message further includes a first order number and merchant information; and the information about the substitute payer further includes an identifier of the substitute payer.

Optionally, the transceiver is further configured to: after sending the payment link to the corresponding substitute payment terminal based on the information about the substitute payer, receive a payment acknowledgment message sent by the payment gateway, where the payment acknowledgment message includes an identifier of a payer and a second order number; and the processor is further configured to: if determining that the identifier of the payer is the same as the identifier of the substitute payer, and the second order number is the same as the first order number, determine that the substitute payer completes payment of the substitute payment amount of the substitute payer.

Optionally, the substitute payment request message further includes a payment amount of a user and an identifier of the user. The processor is further configured to: after determining that each of the substitute payer and the user completes payment, summarize the substitute payment amount of the substitute payer and the payment amount of the user, and generate a payment feedback message, where the payment feedback message is used to indicate that payment of the total payment amount corresponding to the first order number is completed; and

the transceiver is further configured to send the payment feedback message to a payee terminal based on the merchant information.

For technical effects of the payment terminal provided in this embodiment of the present invention, refer to the technical effects in the fourth aspect or the optional manners of the fourth aspect, and details are not described herein again.

According to a thirteenth aspect, an embodiment of the present invention provides a payment system, including:

the payment terminal in the fifth aspect or any optional manner of the fifth aspect, the substitute payment server in the sixth aspect or any optional manner of the sixth aspect, a payment gateway, a substitute payment terminal, and a payee terminal; or the payment terminal in the seventh aspect or any optional manner of the seventh aspect, the substitute payment server in the eighth aspect or any optional manner of the eighth aspect, a payment gateway, a substitute payment terminal, and a payee terminal; or the payment terminal in the ninth aspect, the substitute payment server in the tenth aspect, a payment gateway, a substitute payment terminal, and a payee terminal; or the payment terminal in the eleventh aspect, the substitute payment server in the twelfth aspect, a payment gateway, a substitute payment terminal, and a payee terminal.

### BRIEF DESCRIPTION OF DRAWINGS

To describe the technical solutions in the embodiments of the present invention or the prior art more clearly, the following briefly describes the accompanying drawings required for describing the embodiments or the prior art. Apparently, the accompanying drawings in the following description show merely some embodiments of the present invention.

FIG. 1 shows a payment system according to an embodiment of the present invention;

FIG. 2 is a schematic diagram of a client installed in a form of an independent APP according to an embodiment of the present invention;

FIG. 3 is a schematic diagram of a client installed in a form of a plug-in according to an embodiment of the present invention;

FIG. 4A, FIG. 4B, and FIG. 4C are a flowchart 1 of a payment method according to an embodiment of the present invention;

FIG. 5 is a schematic diagram of an order interface according to an embodiment of the present invention;

FIG. 6 is a schematic diagram of an amount division interface according to an embodiment of the present invention;

FIG. 7 is a schematic diagram of a substitute payment interface according to an embodiment of the present invention;

FIG. 8A, FIG. 8B, and FIG. 8C are a flowchart 2 of a payment method according to an embodiment of the present invention;

FIG. 9A and FIG. 9B are a flowchart 3 of a payment method according to an embodiment of the present invention;

FIG. 10 is a schematic structural diagram of hardware of a payment terminal according to an embodiment of the present invention;

FIG. 11 is a schematic structural diagram of hardware of a substitute payment server according to an embodiment of the present invention;

FIG. 12 is a schematic structural diagram 1 of a payment terminal according to an embodiment of the present invention;

FIG. 13 is a schematic structural diagram 2 of a payment terminal according to an embodiment of the present invention;

FIG. 14 is a schematic structural diagram 1 of a substitute payment server according to an embodiment of the present invention;

FIG. 15 is a schematic structural diagram 2 of a substitute payment server according to an embodiment of the present invention;

FIG. 16 is a schematic structural diagram 3 of a payment terminal according to an embodiment of the present invention;

FIG. 17 is a schematic structural diagram 3 of a substitute payment server according to an embodiment of the present invention; and

FIG. 18 is a schematic structural diagram 4 of a substitute payment server according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some rather than all of the embodiments of the present invention.

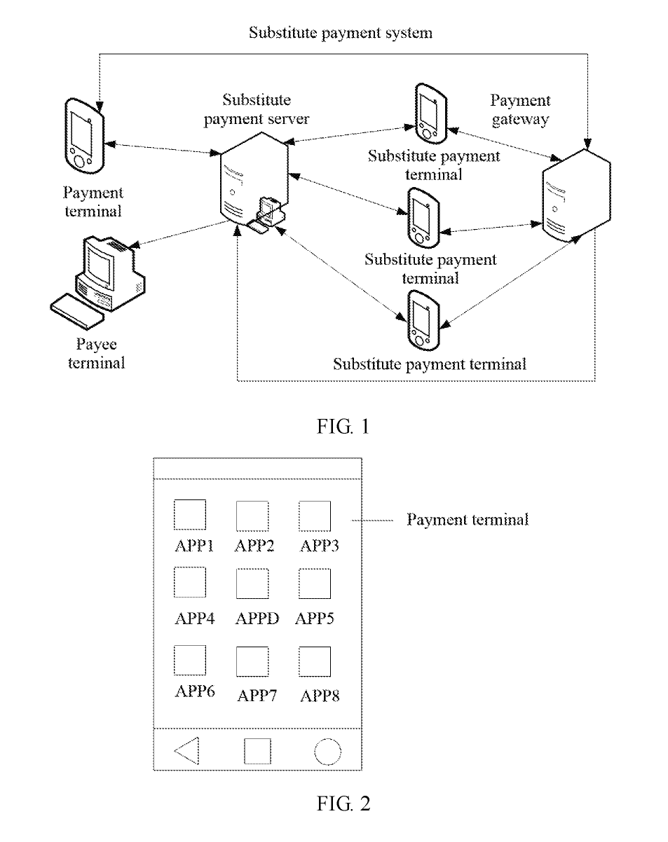

An embodiment of the present invention is applied to a payment system. As shown in FIG. 1, the payment system includes a payment terminal of a user, a substitute payment terminal, a substitute payment server, a payment gateway, and a payee terminal. The payment terminal and the at least two substitute payment terminals each pay an amount by using the payment gateway. The payment gateway is responsible for performing amount transaction with a payment platform (for example, a bank or a third-party platform), and notifying the substitute payment server after payment of each amount is completed. The substitute payment server is responsible for processing a substitute payment request of the payment terminal, generating substitute payment links based on substitute payment amounts, sent by the payment terminal, of substitute payers, sending the substitute payment links to substitute payment terminals, and summarizing amounts paid by substitute payers, to feed back a payment result to the payee terminal. It should be noted that, the payee terminal in this embodiment of the present invention is a payment terminal of a merchant.

The terminal in the present invention may include any terminal device such as a mobile phone, a tablet computer, a personal digital assistant (English full name: Personal Digital Assistant, PDA for short), a point of sales (English full name: Point of Sales, POS for short) terminal, a wearable device, a smartwatch, and an in-vehicle computer.

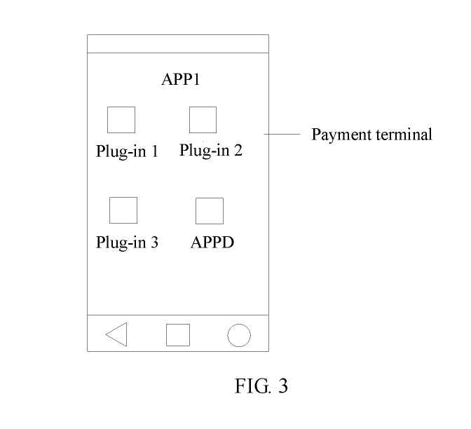

It should be noted that, in this embodiment of the present invention, the payment terminal may run a client installed in the payment terminal, to perform a payment method provided in an embodiment of the present invention. Assuming that the client is an “APPD”, as shown in FIG. 2, the APPD may be installed in the payment terminal in a form of an independent APP. Alternatively, the APPD may be installed in an existing APP of the payment terminal in a form of a plug-in. For example, as shown in FIG. 3, the client is installed in an APP1 of the payment terminal in a form of a plug-in.

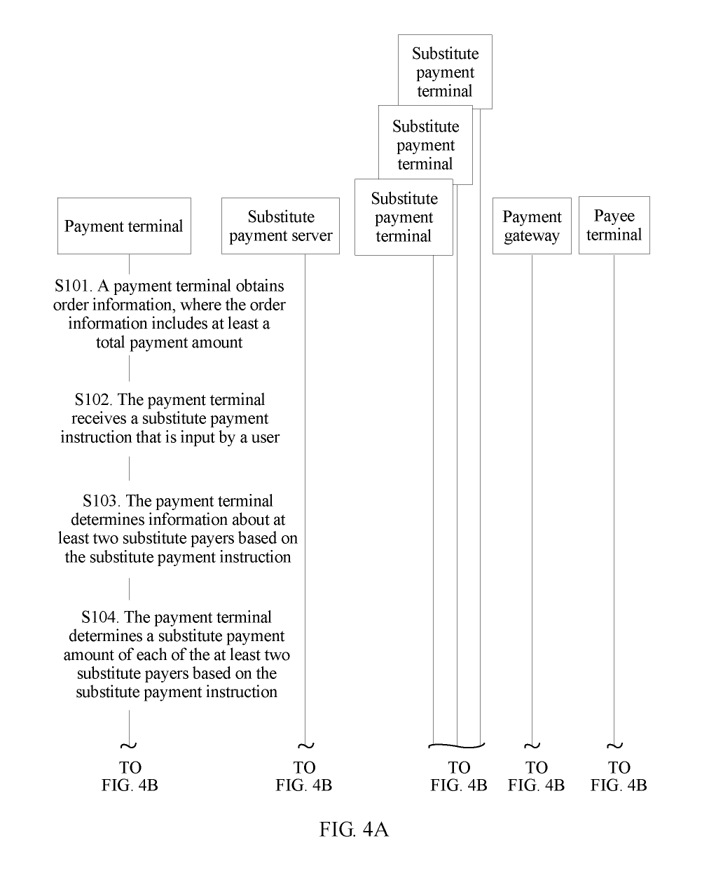

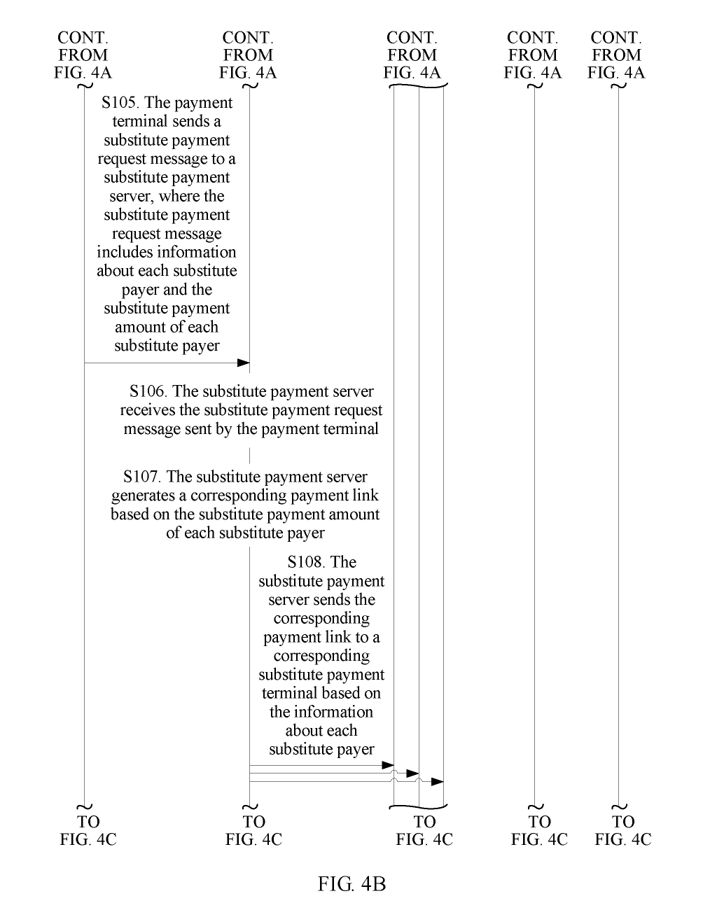

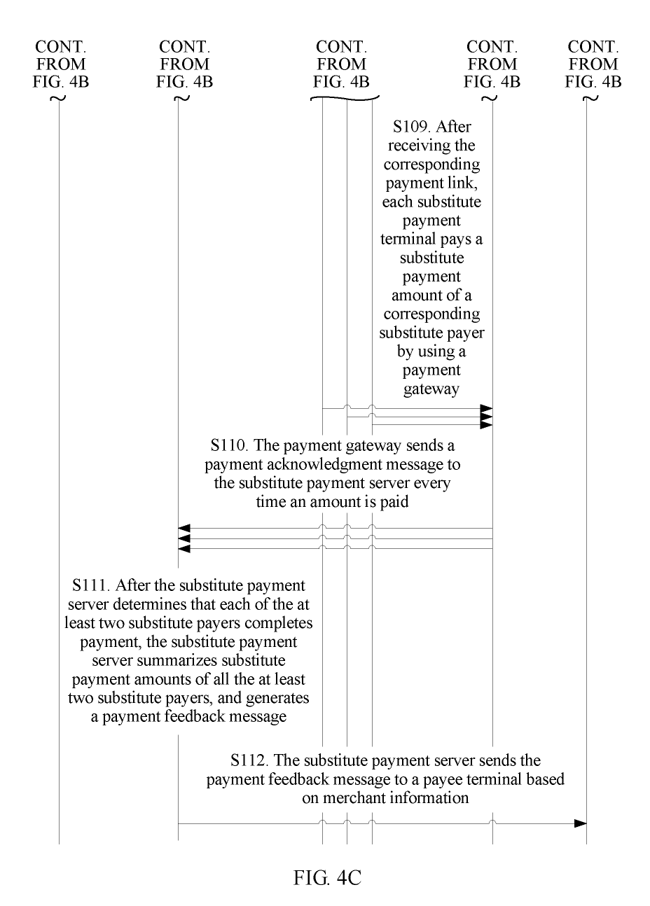

Based on the payment system shown in FIG. 1, an embodiment of the present invention provides a payment method. As shown in FIG. 4A, FIG. 4B, and FIG. 4C, the method may include the following steps.

S101. A payment terminal obtains order information, where the order information includes at least a total payment amount.

The order information may further include a first order number and merchant information.

Further, the order information may further include goods information of goods purchased by a user, and the like.

In this embodiment of the present invention, the payment terminal may obtain the order information by scanning a two-dimensional barcode of payment, or may generate the order information when the user purchases the goods on a shopping APP.

S102. The payment terminal receives a substitute payment instruction that is input by a user.

The substitute payment instruction may include instructions that are input by the user into the payment terminal by using an input unit of the payment terminal, including a substitute payment triggering instruction, a selection instruction, a confirmation instruction, and other instructions used to indicate various types of information.

S103. The payment terminal determines information about at least two substitute payers based on the substitute payment instruction.

Specifically, in this embodiment of the present invention, the substitute payment instruction that is input by the user may include the substitute payment triggering instruction and the selection instruction, and the information about the at least two substitute payers may include contact information of each of the at least two substitute payers.

Further, the information about the at least two substitute payers may further include an identifier of each substitute payer, for example, a name or a nickname of each substitute payer.

It may be understood that, when the user needs substitute payment of another person, the user may tap a substitute payment button displayed on the payment terminal, to input the substitute payment triggering instruction into the payment terminal, so that the payment terminal determines, based on the substitute payment instruction, that a total payment amount of the order needs substitute payment of another person.

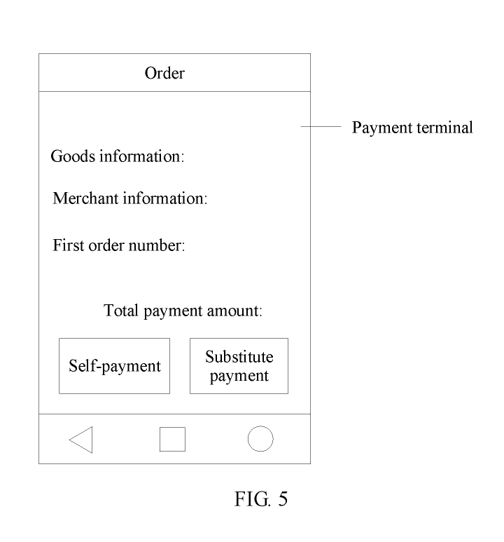

For example, FIG. 5 shows a possible order interface, including goods information, a first order number, merchant information, a total payment amount, a “self-payment” button, a “substitute payment” button, and the like. When the user needs substitute payment of another person, the user may tap the “substitute payment” button displayed in the order interface, to input the substitute payment triggering instruction into the payment terminal.

After the payment terminal receives the substitute payment triggering instruction that is input by the user, the payment terminal may read and display, based on the substitute payment triggering instruction, a contact list stored on the payment terminal.

The contact list may be any one or more address books stored on the payment terminal. For example, the contact list may be a system address book (for example, an address book stored in a SIM card in a mobile phone) of the payment terminal, including a mobile phone number of a contact and a name of the contact; or may be a friend list of an APP installed in the payment terminal, for example, an address book of a social APP, a friend list of a shopping APP, or a friend list of a payment APP.

It should be noted that, if the payment terminal runs an independent APP to perform the payment method provided in this embodiment of the present invention, the contact list may be the system address book of the payment terminal; if the payment terminal runs a plug-in in an APP to perform the payment method provided in this embodiment of the present invention, for example, when the payment terminal runs a substitute payment plug-in in the shopping APP, the contact list may be the system address book of the payment terminal and/or the address book of the social APP; when the payment terminal runs a substitute payment plug-in in the shopping APP, the contact list may be the system address book of the payment terminal and/or the friend list of the shopping APP.

In this embodiment of the present invention, after the payment terminal displays the contact list, the user may check a substitute payer in the contact list, to input a selection instruction into a substitute payment terminal. The user may check one substitute payer, or may check two or more substitute payers. To embody superiority of the payment method provided in this embodiment of the present invention, in this embodiment of the present invention, two or more substitute payers are used as an example for description.

Further, the payment terminal determines the at least two substitute payers that are selected by the user from the contact list, and then obtains the contact information of each substitute payer from the contact list.

S104. The payment terminal determines a substitute payment amount of each of the at least two substitute payers based on the substitute payment instruction.

A sum of substitute payment amounts of the at least two substitute payers is less than or equal to the total payment amount.

Specifically, in this embodiment of the present invention, the substitute payment instruction further includes the substitute payment amount of each substitute payer, and the payment terminal may determine the substitute payment amount of the substitute payer based on the substitute payment amount, entered by the user, of each substitute payer.

In this embodiment of the present invention, the payment terminal can divide the total payment amount as the user wants, so that all of the total payment amount is subject to substitute payment of the at least two substitute payers, or a part of the total payment amount is subject to substitute payment of the at least two substitute payers, and the user pays a remaining part.

For example, it is assumed that there are three substitute payers: a first substitute payer, a second substitute payer, and a third substitute payer, and the total payment amount is 200 yuan. The payment terminal may divide the total payment amount into 4×50 yuan as the user wants, and the user and the three substitute payers each pay 50 yuan. Alternatively, the payment terminal may divide the total payment amount into 100 yuan and 2×50 yuan, the first substitute payer pays 100 yuan, and the second substitute payer and the third substitute payer each pay 50 yuan.

Optionally, if the payment terminal receives a random allocation instruction that is input by the user, the payment terminal may randomly allocate the substitute payment amount of each substitute payer based on the total payment amount and a quantity of the at least two substitute payers.

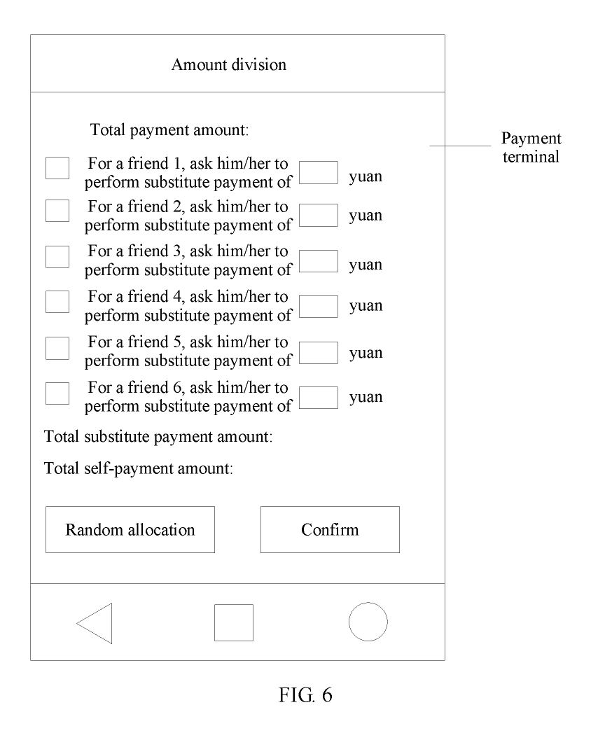

FIG. 6 shows an amount division interface according to an embodiment of the present invention. After receiving the substitute payment triggering instruction that is input by the user, the payment terminal may display the amount division interface shown in FIG. 6. The user may check at least two substitute payers in the amount division interface, and enter a substitute payment amount of each substitute payer, or input a random allocation instruction.

Specifically, the amount division interface includes a “total payment amount”, a “contact list (a friend 1, friend 2, . . . , and a friend 6 shown in FIG. 6)”, a substitute payment amount of each substitute payer, a “random allocation” button, and a “confirm” button. A check box is on the left of a name of each contact in the contact list, and is used by the user to select a substitute payer. A substitute payment amount entry box is on the right of the name of each contact, and is used by the user to enter a wanted substitute payment amount of the substitute payer.

It may be understood that, when selecting a substitute payer, the user may enter a substitute payment amount of the substitute payer, and tap the “confirm” button. It should be noted that, before the user taps the “confirm” button, the user may change the selected substitute payer and modify the substitute payment amount of each substitute payer as the user wants, and after the user taps the “confirm” button, the payment terminal may determine substitute payers finally selected by the user and an amount, finally entered by the user, of each substitute payer.

Optionally, the substitute payment instruction may further include a random allocation instruction. After completing selection of all the substitute payers, the user may tap the “random allocation” button, to input the random allocation instruction into the payment terminal. According to the random allocation instruction, the payment terminal determines a quantity of the at least two substitute payers that are selected by the user, and randomly allocates the substitute payment amount of each substitute payer based on the total payment amount and the quantity of the at least two substitute payers, to obtain a random allocation result of the total payment amount. After the user taps the “confirm” button to input a confirmation instruction into the payment terminal, the payment terminal may determine the substitute payment amount of each substitute payer based on the random allocation result.

It may be understood that, before the user taps the “confirm” button, if the user does not want a current random allocation result, the user may tap the “random allocation” button again, so that the payment terminal randomly re-allocates the substitute payment amount of each substitute payer, to obtain a new random allocation result, until the user obtains a wanted result. Before the user taps the “confirm” button, the user may also change a selected substitute payer as the user wants, and the payment terminal determines a quantity of the at least two substitute payers in real time based on selection of the user, and randomly allocates the substitute payment amount of each substitute payer based on the total payment amount and the quantity of the at least two substitute payers, to obtain a new random allocation result.

Optionally, as shown in FIG. 6, the amount division interface may further include a sum of substitute payment amounts of the at least two substitute payers, namely, a total substitute payment amount, and a payment amount of the user, namely, a total self-payment amount.

In this embodiment of the present invention, the payment terminal may calculate the payment amount (namely, the total self-payment amount) of the user in real time based on the total payment amount and the sum (namely, the total substitute payment amount) of the substitute payment amounts of the at least two substitute payers.

S105. The payment terminal sends a substitute payment request message to a substitute payment server, where the substitute payment request message includes information about each substitute payer and the substitute payment amount of each substitute payer.

The substitute payment request message may also carry the first order number and the merchant information in the order information.

The substitute payment request message is used to request the substitute payment server to generate at least two payment links respectively corresponding to the substitute payment amounts of all the substitute payers and respectively send the at least two payment links to corresponding substitute payment terminals, so that the at least two substitute payers perform substitute payment.

It may be understood that, by using the payment method provided in this embodiment of the present invention, the payment terminal may divide the total payment amount, and the at least two substitute payers each pay a part of the total payment amount, thereby reducing the substitute payment amount of each substitute payer, and greatly increasing acceptance of the substitute payment amount by the substitute payer.

S106. The substitute payment server receives the substitute payment request message sent by the payment terminal.

S107. The substitute payment server generates a corresponding payment link based on the substitute payment amount of each substitute payer.

For example, it is assumed that substitute payers are a first substitute payer, a second substitute payer, and a third substitute payer, a substitute payment amount of the first substitute payer is 50 yuan, a substitute payment amount of the second substitute payer is 30 yuan, and a substitute payment amount of the third substitute payer is 10 yuan. After receiving the substitute payment request message sent by the payment terminal, the substitute payment server respectively generates a payment link corresponding to 50 yuan, a payment link corresponding to 30 yuan, and a payment link corresponding to 10 yuan.

S108. The substitute payment server sends the corresponding payment link to a corresponding substitute payment terminal based on the information about each substitute payer.

Specifically, the information about the substitute payer includes contact information of the substitute payer, and the substitute payment server may specifically send a notification message to the corresponding substitute payment terminal based on the contact information of the substitute payer. The substitute payment terminal runs an application program corresponding to the contact information of the substitute payer.

For example, it is assumed that information about the first substitute payer includes a phone number of the first substitute payer, information about the second substitute payer includes a social account of the second substitute payer, and information about the third substitute payer includes a phone number of the third substitute payer.

A SIM card corresponding to the phone number of the first substitute payer is inserted into a first substitute payment terminal. The substitute payment server may send the payment link corresponding to 50 yuan to the first substitute payment terminal based on the phone number of the first substitute payer by using an SMS message.

A second substitute payment terminal runs a social APP corresponding to the social account of the second substitute payer. The substitute payment server sends the payment link corresponding to 30 yuan to the first substitute payment terminal based on the social account of the second substitute payer. When running the social APP, the second substitute payment terminal may receive the payment link corresponding to 30 yuan.

A SIM card corresponding to the phone number of the third substitute payer is inserted into a third substitute payment terminal. The substitute payment server may send the payment link corresponding to 10 yuan to the third substitute payment terminal based on the phone number of the third substitute payer by using an SMS message.

S109. After receiving the corresponding payment link, each substitute payment terminal pays a substitute payment amount of a corresponding substitute payer by using a payment gateway.

Specifically, after the substitute payment terminal receives the corresponding payment link, the substitute payer may tap the payment link. After the substitute payment terminal receives an instruction generated after the substitute payer taps the payment link, the substitute payment terminal skips to a payment page, and displays the payment page to the substitute payer, to guide the substitute payer in entering related information, including an account password, a payment confirmation instruction, and the like. The substitute payment terminal exchanges information with the payment gateway, and the payment gateway applies for payment of the amount from a payment system such as a bank, Alipay, or Tenpay, to complete payment of the substitute payment amount of the substitute payer.

A specific implementation in which the substitute payment terminal pays the substitute payment amount of the substitute payer by using the payment gateway is the same as a manner in which a payment terminal pays an amount by using a payment gateway in the prior art, and details are not described herein.

For example, the first substitute payer is used as an example. After the first substitute payment terminal receives a notification message including the payment link corresponding to 50 yuan, the first substitute payer taps the payment link corresponding to 50 yuan. After receiving an instruction generated after the first substitute payer taps the payment link corresponding to 50 yuan, the first substitute payment terminal enters a payment page, and displays the payment page to the first substitute payer.

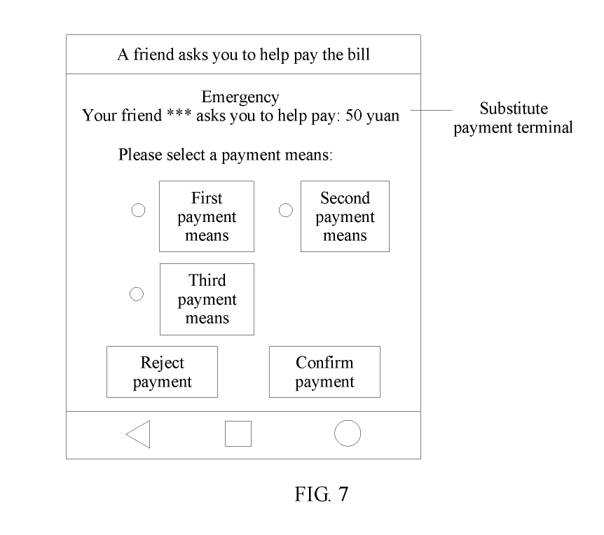

For example, as shown in FIG. 7, the substitute payment amount of the first substitute payer, for example, “Your friend *** asks you to help pay: 50 yuan” may be displayed on the payment page. Signs of a plurality of payment means, for example, a sign of a first payment means, a sign of a second payment means, and a sign of a third payment means, may be further displayed on the payment page. A check box is displayed on the left of a sign of each payment means, and is used by the first substitute payer to select an appropriate payment means.

Further, a “confirm payment” button, a “reject payment” button, and the like may be further displayed on the payment page.

After the first substitute payer checks a payment means, and taps the “confirm payment” button, the first substitute payment terminal pays 50 yuan by using the payment gateway.

It should be noted that, if the first substitute payer does not want to perform substitute payment for the user, the first substitute payer may tap the “reject payment” button, then the first substitute payment terminal may send a substitute payment rejection message to the substitute payment server, and the substitute payment server instructs the payment terminal to determine another substitute payer to perform substitute payment of the 50 yuan, or the user pays the 50 yuan.

S110. The payment gateway sends a payment acknowledgment message to the substitute payment server every time an amount is paid.

It should be noted that, in this embodiment of the present invention, the payment acknowledgment message is used to notify the substitute payment server that payment of an amount is completed. The payment acknowledgment message carries an identifier of a payer and a second order number.

S111. After the substitute payment server determines that each of the at least two substitute payers completes payment, the substitute payment server summarizes substitute payment amounts of all the at least two substitute payers, and generates a payment feedback message.

In this embodiment of the present invention, the substitute payment server receives the payment acknowledgment message sent by the payment gateway, if the substitute payment server determines that the identifier of the payer is the same as an identifier of a substitute payer, and the second order number is the same as the first order number, the substitute payment server may determine that the substitute payer completes payment of a substitute payment amount of the substitute payer.

After the substitute payment server determines that each of the at least two substitute payers completes payment, the substitute payment server summarizes the substitute payment amounts of all the at least two substitute payers, that is, adds up the substitute payment amounts of all the substitute payers, determines that payment of the total payment amount corresponding to the first order number is completed, and generates the payment feedback message based on the first order number. The payment feedback message is used to indicate that payment of the total payment amount corresponding to the first order number is completed.

For example, the substitute payment request message received by the substitute payment server includes an identifier of the first substitute payer, an identifier of the second substitute payer, an identifier of the third substitute payer, and the first order number. After sending a notification message to each of the first substitute payer, the second substitute payer, and the third substitute payer, the substitute payment server receives at least three payment acknowledgment messages sent by the payment gateway.

If the substitute payment server determines that the at least three payment acknowledgment messages include a payment acknowledgment message carrying an identifier of a payer that is the same as the identifier of the first substitute payer and a second order number that is the same as the first order number, the substitute payment server determines that the first substitute payer completes payment.

If the substitute payment server determines that the at least three payment acknowledgment messages include a payment acknowledgment message carrying an identifier of a payer that is the same as the identifier of the second substitute payer and a second order number that is the same as the first order number, the substitute payment server determines that the second substitute payer completes payment.

If the substitute payment server determines that the at least three payment acknowledgment messages include a payment acknowledgment message carrying an identifier of a payer that is the same as the identifier of the third substitute payer and a second order number that is the same as the first order number, the substitute payment server determines that the third substitute payer completes payment.

Further, the substitute payment server adds up the substitute payment amount 50 yuan of the first substitute payer, the substitute payment amount 30 yuan of the second substitute payer, and the substitute payment amount 10 yuan of the third substitute payer, and determines that payment of 80 yuan corresponding to the first order number is completed, and the substitute payment server may generate a payment feedback message based on the first order number, to indicate, to a payee terminal, that payment of 80 yuan corresponding to the first order number is completed.

S112. The substitute payment server sends the payment feedback message to the payee terminal based on merchant information.

It may be understood that, after the payee terminal receives the payment feedback message, a settlement procedure of an order corresponding to the first order number may be completed.

It may be understood that, in this embodiment of the present invention, after receiving the notification message, the substitute payer may directly tap the payment link to enter a payment web page, to perform a corresponding operation for payment, without logging in to an account the same as that of the user, so that a substitute payment process is simpler and clearer.

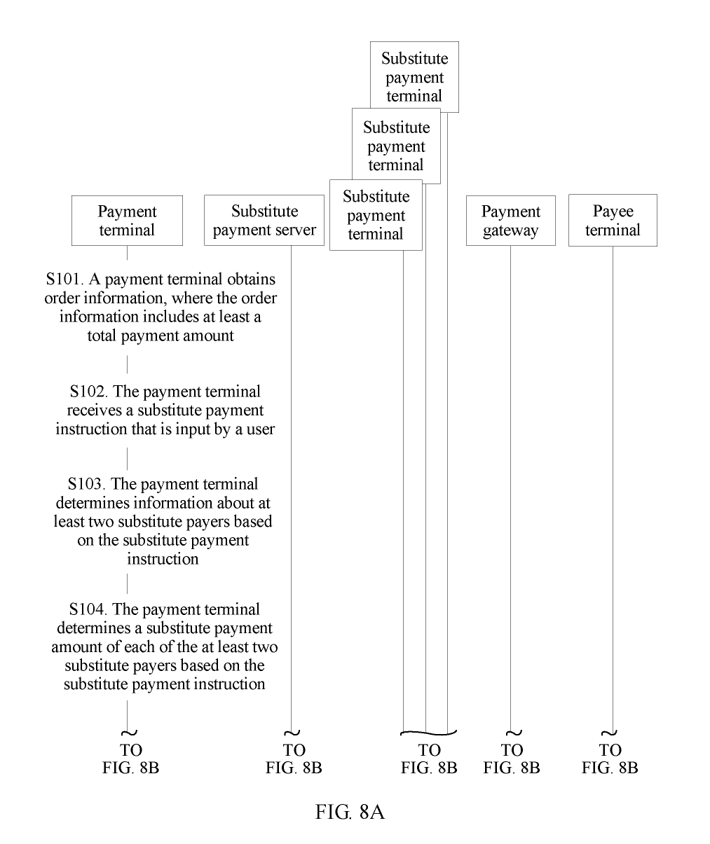

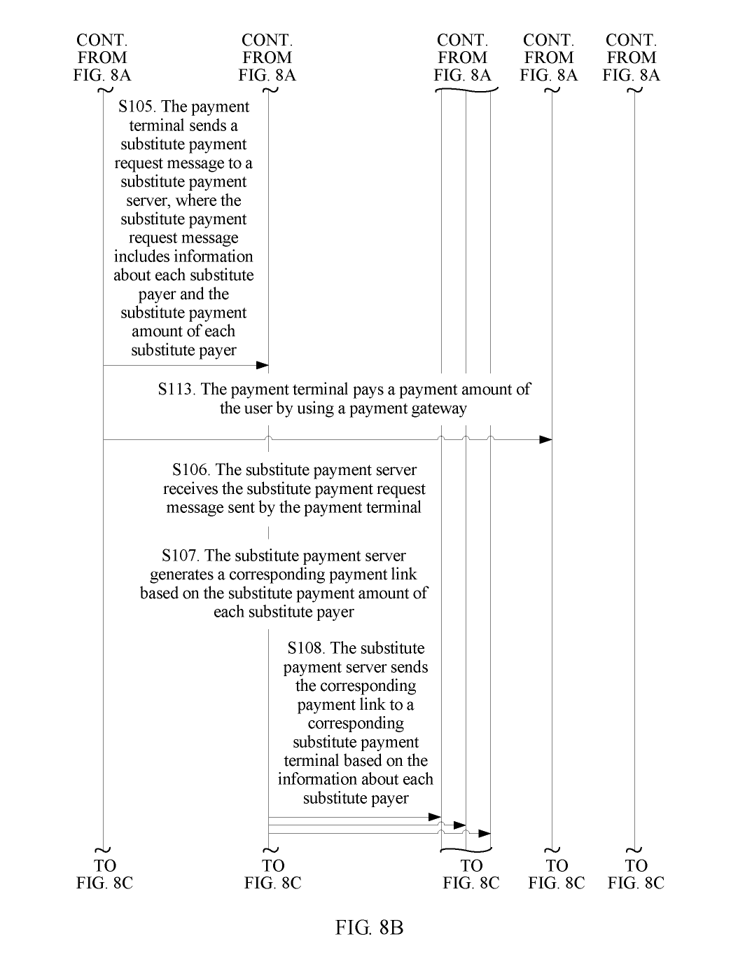

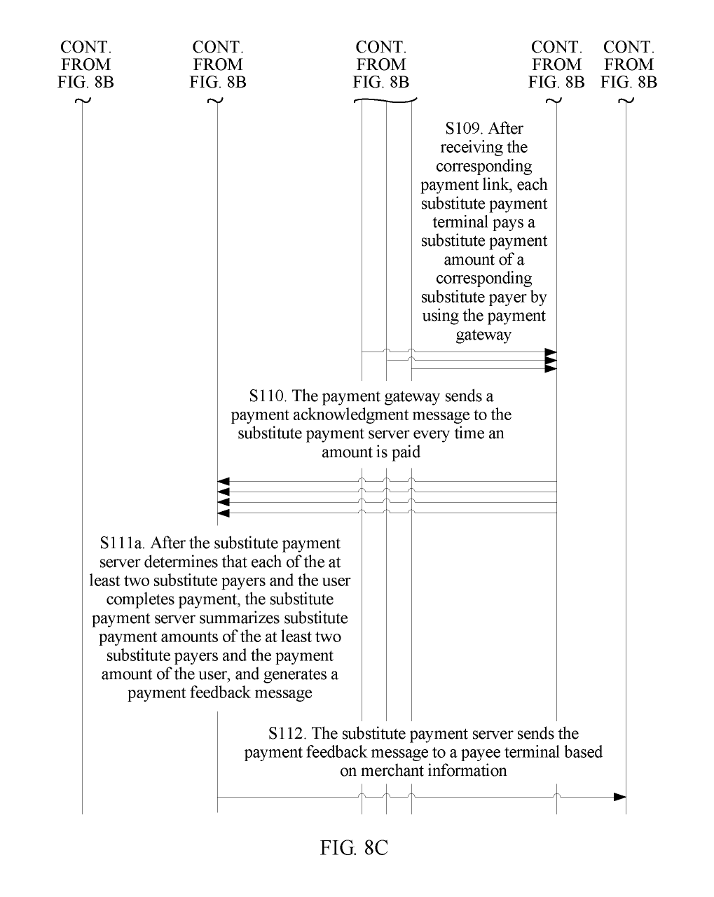

Optionally, with reference to FIG. 4A, FIG. 4B, and FIG. 4C, as shown in FIG. 8A, FIG. 8B, and FIG. 8C, after S105, the method further includes:

S113. The payment terminal pays a payment amount of the user by using the payment gateway.

In this embodiment, the sum (namely, the total substitute payment amount) of the substitute payment amounts of the at least two substitute payers is less than the total payment amount, a payment amount (namely, the total self-payment amount) in the total payment amount other than the total substitute payment amount is paid by the user, and the payment terminal may pay the payment amount of the user by using the payment gateway.

It should be noted that, the substitute payment request message sent by the payment terminal to the substitute payment server may also carry an identifier of the user and the payment amount of the user, so that the substitute payment server determines whether the user completes payment of the payment amount of the user.

Further, in this embodiment of the present invention, S111 may specifically include:

S111a. After the substitute payment server determines that each of the at least two substitute payers and the user completes payment, the substitute payment server summarizes substitute payment amounts of the at least two substitute payers and the payment amount of the user, and generates a payment feedback message.

It may be understood that, when the substitute payment server determines that an identifier of a payer that is carried in a received payment acknowledgment message is the same as the identifier of the user, and a second order number is the same as the first order number, the substitute payment server may determine that the user completes payment of the payment amount of the user. Then the substitute payment server may summarize the payment amount of the user and the substitute payment amounts of the at least two substitute payers, and generate the payment feedback message, to indicate, to the payee terminal, that payment of the total payment amount corresponding to the first order number is completed.

By using the payment method provided in this embodiment of the present invention, the payment terminal may determine the information about the at least two substitute payers, and divide the total payment amount to determine the substitute payment amount of each of the at least two substitute payers. The information about each substitute payer and the substitute payment amount of each substitute payer are carried in the substitute payment request message and sent to the substitute payment server. The substitute payment server generates the payment link corresponding to the substitute payment amount of each substitute payer, and sends each payment link to the corresponding substitute payment terminal, so that the at least two substitute payers pay the substitute payment amounts of the substitute payers. By using the payment method, the at least two substitute payers can perform substitute payment for a same order, and each substitute payer needs to perform substitute payment of only a part of a total payment amount of the order, thereby reducing a substitute payment amount of the substitute payer, and increasing an order transaction success rate.

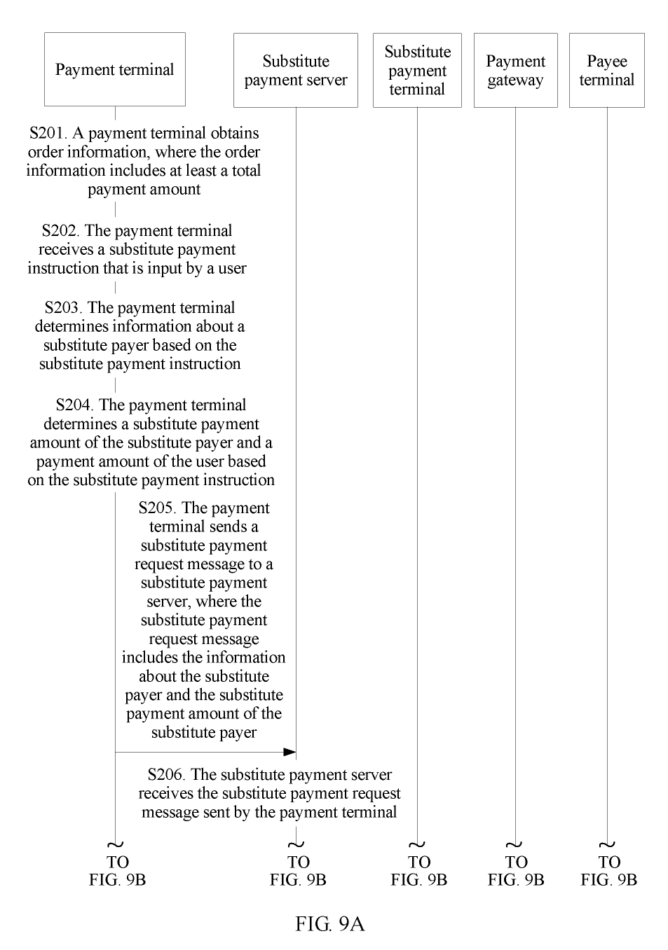

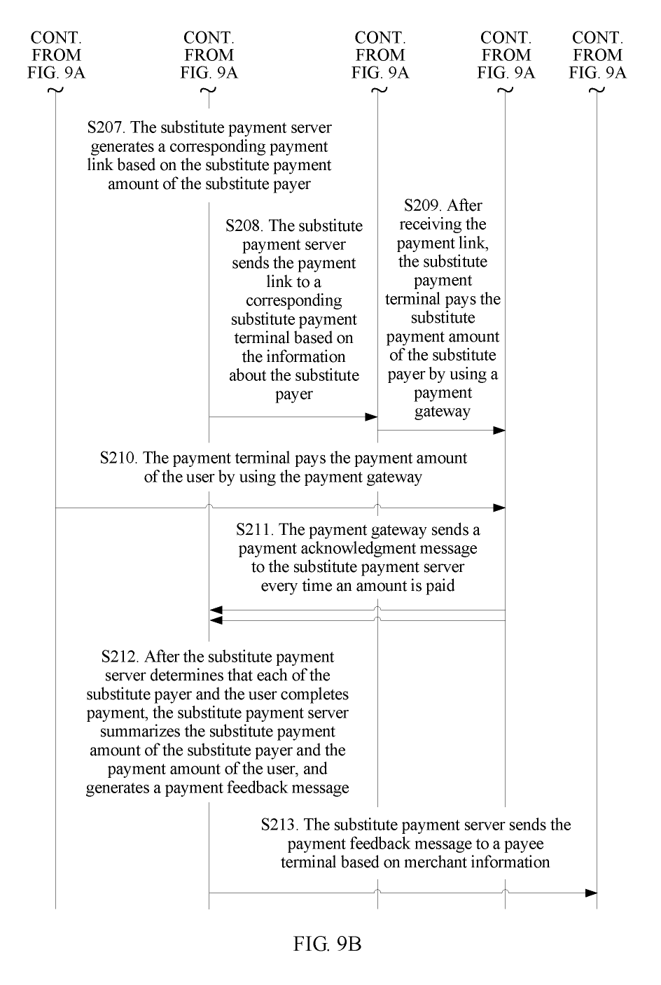

Optionally, an embodiment of the present invention provides a payment method. As shown in FIG. 9A and FIG. 9B, the method may include the following steps.

S201. A payment terminal obtains order information, where the order information includes at least a total payment amount.

S202. The payment terminal receives a substitute payment instruction that is input by a user.

S203. The payment terminal determines information about a substitute payer based on the substitute payment instruction.

Specifically, the substitute payment instruction includes a substitute payment triggering instruction and a selection instruction, and the information about the substitute payer includes contact information of the substitute payer.

Further, the information about the substitute payer may further include an identifier of the substitute payer, for example, a name or a nickname of the substitute payer.

Specifically, for a manner in which the payment terminal determines information about a substitute payer based on the substitute payment instruction in this embodiment of the present invention, refer to the manner in which the payment terminal determines information about at least two substitute payers based on the substitute payment instruction in S103, and details are not described herein again.

S204. The payment terminal determines a substitute payment amount of the substitute payer and a payment amount of the user based on the substitute payment instruction.

The substitute payment amount of the substitute payer is less than the total payment amount.

In this embodiment of the present invention, the payment terminal can divide the total payment amount as the user wants, so that a part of the total payment amount is subject to substitute payment of the substitute payer, and the user pays a remaining part. Specifically, the substitute payment instruction includes the substitute payment amount of the substitute payer, and the payment terminal may determine the substitute payment amount of the substitute payer based on the received substitute payment amount, entered by the user, of the substitute payer, and then calculate the payment amount of the user based on the substitute payment amount of the substitute payer and the total payment amount.

Optionally, the substitute payment instruction may further include a random allocation instruction. After receiving the random allocation instruction that is input by the user, the payment terminal may randomly allocate the total payment amount according to the random allocation instruction.

Specifically, for a method in which the payment terminal randomly allocates the total payment amount in this embodiment of the present invention, refer to the method in which the payment terminal randomly allocates the total payment amount in the embodiment shown in FIG. 6, and details are not described herein again.

S205. The payment terminal sends a substitute payment request message to a substitute payment server, where the substitute payment request message includes the information about the substitute payer and the substitute payment amount of the substitute payer.

The substitute payment request message may also carry a first order number and merchant information in the order information.

The substitute payment request message is used to request the substitute payment server to generate a payment link corresponding to the substitute payment amount of the substitute payer and send the payment link to a corresponding substitute payment terminal, so that the substitute payer performs substitute payment.

It may be understood that, by using the payment method provided in this embodiment of the present invention, the payment terminal may divide the total payment amount, and the user and the substitute payer each pay a part of the total payment amount, thereby reducing the substitute payment amount of the substitute payer, and greatly increasing acceptance of the substitute payment amount by the substitute payer.

S206. The substitute payment server receives the substitute payment request message sent by the payment terminal.

S207. The substitute payment server generates a corresponding payment link based on the substitute payment amount of the substitute payer.

For example, it is assumed that the substitute payment amount of the substitute payer is 50 yuan. After receiving the substitute payment request message sent by the payment terminal, the substitute payment server generates a payment link corresponding to 50 yuan.

S208. The substitute payment server sends the payment link to a corresponding substitute payment terminal based on the information about the substitute payer.

Specifically, the information about the substitute payer includes the contact information of the substitute payer, and the substitute payment server may specifically send the payment link to the substitute payment terminal based on the contact information of the substitute payer. The substitute payment terminal runs an application program corresponding to the contact information of the substitute payer.

For example, if the information about the substitute payer includes a social account of the substitute payer, the substitute payment terminal runs a social APP corresponding to the social account of the substitute payer, and the substitute payment server sends the payment link corresponding to 50 yuan to the first substitute payment terminal based on the social account of the substitute payer. When running the social APP, the substitute payment terminal may receive the payment link corresponding to 50 yuan.

If the information about the substitute payer includes a phone number of the substitute payer, a SIM card corresponding to the phone number of the substitute payer is inserted into the substitute payment terminal, and the substitute payment server may send the payment link corresponding to 50 yuan to the substitute payment terminal based on the phone number of the substitute payer by using an SMS message.

S209. After receiving the payment link, the substitute payment terminal pays the substitute payment amount of the substitute payer by using a payment gateway.

Specifically, after the substitute payment terminal receives the corresponding payment link, the substitute payer may tap the payment link. After the substitute payment terminal receives an instruction generated after the substitute payer taps the payment link, the substitute payment terminal skips to a payment page, and displays the payment page to the substitute payer, to guide the substitute payer in entering related information, including an account password, a payment confirmation instruction, and the like. The substitute payment terminal exchanges information with the payment gateway, and the payment gateway applies for payment of the amount from a payment system such as a bank, Alipay, or Tenpay, to complete payment of the substitute payment amount of the substitute payer.

A specific implementation in which the substitute payment terminal pays the substitute payment amount of the substitute payer by using the payment gateway is the same as a manner in which a payment terminal pays an amount by using a payment gateway in the prior art, and details are not described herein.

S210. The payment terminal pays the payment amount of the user by using the payment gateway.

Specifically, for a specific implementation in which the payment terminal pays the payment amount of the user by using the payment gateway is the same as a manner in which a payment terminal pays an amount by using a payment gateway in the prior art, and details are not described herein.

S211. The payment gateway sends a payment acknowledgment message to the substitute payment server every time an amount is paid.

The payment acknowledgment message carries an identifier of a payer and a second order number, and the payment acknowledgment message is used to notify the substitute payment server that payment of an amount is completed.

S212. After the substitute payment server determines that each of the substitute payer and the user completes payment, the substitute payment server summarizes the substitute payment amount of the substitute payer and the payment amount of the user, and generates a payment feedback message.

Specifically, for a method in which the substitute payment server determines that the substitute payer completes payment and the user completes payment, and the substitute payment server generates a payment feedback message in this embodiment of the present invention, refer to the specific description in S111 in the embodiment shown in FIG. 4A, FIG. 4B, and FIG. 4C, and details are not described herein again.

S213. The substitute payment server sends the payment feedback message to a payee terminal based on merchant information.

It may be understood that, after the payee terminal receives the payment feedback message, a settlement procedure of an order corresponding to the first order number may be completed.

It may be understood that, in this embodiment of the present invention, after receiving a notification message, the substitute payer may directly tap the payment link to enter a payment web page, to perform a corresponding operation for payment, without logging in to an account the same as that of the user, so that a substitute payment process is simpler and clearer.

This embodiment of the present invention provides a payment method. After determining the information about the substitute payer, the payment terminal can divide the total payment amount to determine the substitute payment amount of the substitute payer and the payment amount of the user. The user pays the payment amount of the user. The information about the substitute payer and the substitute payment amount of the substitute payer are carried in the substitute payment request message and sent to the substitute payment server. The substitute payment server generates the payment link corresponding to the substitute payment amount of the substitute payer, and sends the payment link to the corresponding substitute payment terminal, so that the substitute payer pays the substitute payment amount of the substitute payer. By using the payment method provided in this embodiment of the present invention, the user and the substitute payer pay for a same order, that is, the substitute payer and the user each pay a part of a total payment amount of the order, thereby reducing a substitute payment amount of the substitute payer, and increasing an order transaction success rate.

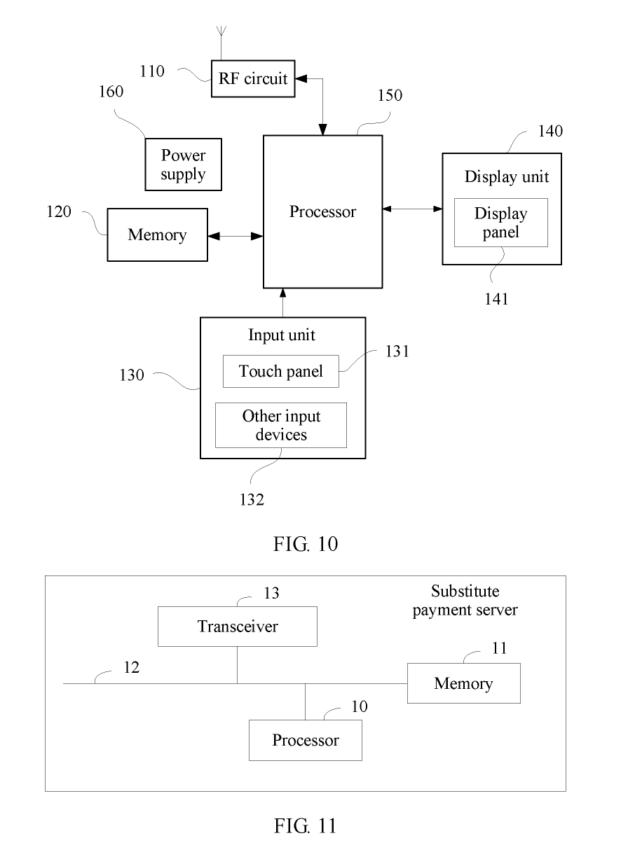

As shown in FIG. 10, an embodiment of the present invention provides a payment terminal. The payment terminal can perform a method procedure that is in the embodiment shown in FIG. 4A, FIG. 4B, and FIG. 4C, FIG. 8A, FIG. 8B, and FIG. 8C, or FIG. 9A and FIG. 9B and that is performed by a payment terminal. For ease of description, FIG. 9A and FIG. 9B show only parts related to this embodiment of the present invention. For specific technical details that are not disclosed, refer to the embodiments of the present invention shown in FIG. 2 to FIG. 6, FIG. 8A, FIG. 8B, and FIG. 8C, and FIG. 9A and FIG. 9B.

Referring to FIG. 10, the payment terminal provided in this embodiment of the present invention includes components such as a radio frequency (English: Radio Frequency, RF) circuit 110, a memory 120, an input unit 130, a display unit 140, a processor 150, and a power supply 160. A person skilled in the art may understand that the structure of the payment terminal shown in FIG. 9A and FIG. 9B does not constitute a limitation on the payment terminal, and the payment terminal may include more or fewer components than those shown in the figure, or combine some components, or have different component arrangements.

The following specifically describes the components of the payment terminal with reference to FIG. 10.

The RF circuit 110 may be configured to receive and send information, for example, exchange information with devices such as a substitute payment server and a payment gateway, and send the received information to the processor 150 for processing. Generally, the RF circuit 110 includes, but is not limited to, an antenna, at least one amplifier, a transceiver, a coupler, a low noise amplifier (English: Low Noise Amplifier, LNA), a duplexer, and the like. In addition, the RF circuit 110 may further communicate with a network and another device through wireless communication. The wireless communication may use any communications standard or protocol, including but not limited to: a Global System for Mobile Communications (English: Global System for Mobile Communications, GSM), a general packet radio service (English: General Packet Radio Service, GPRS), Code Division Multiple Access (English: Code Division Multiple Access, CDMA), Wideband Code Division Multiple Access (English: Wideband Code Division Multiple Access, WCDMA), Long Term Evolution (English: Long Term Evolution, LTE), an email, a short message service (English: Short Message Service, SMS), and the like.

The memory 120 may be configured to store a software program and a module. The processor 150 runs the software program and the module that are stored in the memory 120, so that the payment terminal performs the payment method shown in FIG. 4A, FIG. 4B, and FIG. 4C, FIG. 8A, FIG. 8B, and FIG. 8C, or FIG. 9A and FIG. 9B. The memory 120 may mainly include a program storage area and a data storage area. The program storage area may store an operating system, an application program required for implementing the payment method, and the like. The data storage area may store a contact list, information about a substitute payer, an identifier of a user, data generated when the payment terminal performs the payment method, and the like. In addition, the memory 120 may include a volatile memory (English: volatile memory), for example, a random access memory (English: random-access memory, RAM for short); or the memory 31 may include a non-volatile memory (English: non-volatile memory), for example, a read-only memory (English: read-only memory, ROM for short), a flash memory (English: flash memory), a hard disk drive (English: hard disk drive, HDD for short), or a solid-state drive (English: solid-state drive, SSD for short); or the memory 120 may include a combination of the foregoing memories.

The input unit 130 may be configured to receive digit or character information entered by the user, including a substitute payment instruction, a substitute payment amount of the substitute payer, a random allocation instruction, a confirmation instruction, and the like, and further including a related instruction that is input by the user when the payment terminal pays a payment amount of the user by using the payment gateway. Specifically, the input unit 130 may include a touch panel 131 and other input devices 132. The touch panel 131, also referred to as a touchscreen, may collect a touch operation of the user on or near the touch panel 131 (such as an operation of the user on or near the touch panel 131 by using any suitable object or accessory such as a finger or a stylus), and drive a corresponding connection apparatus according to a preset program. Optionally, the touch panel 131 may include two parts: a touch detection apparatus and a touch controller. The touch detection apparatus detects a touch orientation of the user, detects a signal generated by the touch operation, and transfers the signal to the touch controller. The touch controller receives the touch information from the touch detection apparatus, converts the touch information into contact coordinates, and sends the contact coordinates to the processor 150. Moreover, the touch controller can receive and execute a command sent by the processor 150. In addition, for the input unit 130, the touch panel 131 may be a resistive, capacitive, infrared, or surface acoustic wave type touch panel. In addition to the touch panel 131, the input unit 130 may further include the other input devices 132. Specifically, the other input devices 132 may include but are not limited to one or more of a physical keyboard, a functional key (for example, a volume control key or a switch key), a trackball, a mouse, a joystick, and the like.

The display unit 140 may be configured to display the information entered by the user or information provided for the user, and various menus of the payment terminal, including order information, a client, a plug-in, a substitute payment button, an amount division interface, an amount payment interface, and the like. The display unit 140 may include a display panel 141. Optionally, the display panel 141 may be configured in a form of a liquid crystal display (English: Liquid Crystal Display, LCD), an organic light-emitting diode (English: Organic Light-Emitting Diode, OLED), or the like. Further, the touch panel 1131 may cover the display panel 141. After detecting a touch operation on or near the touch panel 131, the touch panel 131 transfers the touch operation to the processor 150, to determine a type of a touch event. The processor 150 then provides a corresponding visual output on the display panel 141 based on the type of the touch event. Although in FIG. 9A and FIG. 9B, the touch panel 131 and the display panel 141 implement input and output functions of the payment terminal as two independent parts, in some embodiments, the touch panel 131 and the display panel 141 may be integrated to implement the input and output functions of the payment terminal, for example, as a transceiver.

The processor 150 is a control center of the payment terminal, and is connected to various parts of the payment terminal by using various interfaces and lines. The processor 150 runs or executes the software program and/or the module stored in the memory 120 and invokes the data stored in the memory 120, to perform the payment method shown in FIG. 4A, FIG. 4B, and FIG. 4C, FIG. 8A, FIG. 8B, and FIG. 8C, or FIG. 9A and FIG. 9B. Optionally, the processor 150 may include one or more processing units. Preferably, the processor 150 may integrate an application processor and a modem processor. The application processor mainly processes an operating system, a user interface, an application program, and the like. The modem processor mainly processes wireless communication. It may be understood that the foregoing modem processor may alternatively not be integrated into the processor 150.

The payment terminal further includes the power supply 160 (such as a battery) for supplying power to the components. Preferably, the power supply may be logically connected to the processor 150 by using a power management system, to implement functions such as charging, discharging, and power consumption management by using the power management system.

Although not shown, the payment terminal may further include a camera, a Bluetooth module, a sensor, an audio circuit, a USB module, and the like, and details are not described herein.

Specifically, in this embodiment of the present invention, when the payment terminal provided in this embodiment of the present invention performs the payment method shown in FIG. 4A, FIG. 4B, and FIG. 4C or FIG. 8A, FIG. 8B, and FIG. 8C, the input unit is configured to receive a substitute payment instruction;

the processor is configured to obtain order information, and determine information about at least two substitute payers and a substitute payment amount of each of the at least two substitute payers based on the substitute payment instruction received by the input unit, where the order information includes at least a total payment amount, and a sum of substitute payment amounts of the at least two substitute payers is less than or equal to the total payment amount; and

the RF circuit is configured to send a substitute payment request message to a substitute payment server, where the substitute payment request message includes information about each substitute payer and the substitute payment amount of each substitute payer that are determined by the processor, and the substitute payment request message is used to request the substitute payment server to generate a payment link corresponding to the substitute payment amount of each substitute payer and send, based on the information about each substitute payer, the payment link corresponding to the substitute payment amount of each substitute payer to a corresponding substitute payment terminal.

The substitute payment instruction includes a substitute payment triggering instruction and a selection instruction, the information about the at least two substitute payers includes contact information of each substitute payer; and the determining, by the processor, information about at least two substitute payers based on the substitute payment instruction is specifically: reading and displaying, based on the substitute payment triggering instruction, a contact list stored on the payment terminal, and determining, based on the selection instruction, contact information of the at least two substitute payers that are selected by a user from the contact list.

The substitute payment instruction includes the substitute payment amount of each substitute payer, and the determining, by the processor, a substitute payment amount of each substitute payer based on the substitute payment instruction is specifically: determining the substitute payment amount of each substitute payer based on the received substitute payment amount of each substitute payer.

Optionally, the substitute payment instruction includes a random allocation instruction. The determining, by the processor, a substitute payment amount of each substitute payer based on the substitute payment instruction is specifically: determining a quantity of the at least two substitute payers based on the received random allocation instruction; randomly allocating the substitute payment amount of each substitute payer based on the total payment amount and the quantity of the at least two substitute payers, to obtain a random allocation result of the total payment amount; and determining the substitute payment amount of each substitute payer based on the random allocation result.

The processor is further configured to: after determining the substitute payment amount of each of the at least two substitute payers, calculate a payment amount of the user based on the total payment amount and the sum of the substitute payment amounts of the at least two substitute payers, and pay the payment amount of the user by using a payment gateway.

The substitute payment request message sent by the RF circuit further includes the payment amount of the user and an identifier of the user.

Optionally, when the payment terminal provided in this embodiment of the present invention performs the payment method shown in FIG. 9A and FIG. 9B, the input unit is configured to receive a substitute payment instruction;

the processor is configured to obtain order information, determine information about a substitute payer, a substitute payment amount of the substitute payer, and a payment amount of a user based on the substitute payment instruction, and pay the payment amount of the user by using a payment gateway, where the order information includes at least a total payment amount, and the substitute payment amount of the substitute payer is less than the payment amount of the user; and

the RF circuit is configured to send a substitute payment request message to a substitute payment server, where the substitute payment request message includes the information about the substitute payer and the substitute payment amount of the substitute payer, and the substitute payment request message is used to request the substitute payment server to generate a payment link corresponding to the substitute payment amount of the substitute payer and send the payment link to a corresponding substitute payment terminal based on the information about the substitute payer.

Further, the substitute payment instruction includes a substitute payment triggering instruction and a selection instruction, the information about the substitute payer includes contact information of the substitute payer, and the determining, by the processor, information about a substitute payer based on the substitute payment instruction is specifically: reading and displaying, based on the substitute payment triggering instruction, a contact list stored on the payment terminal, and determining, based on the selection instruction, the contact information of the substitute payer that is selected by the user from the contact list.

Further, the substitute payment instruction includes the substitute payment amount of the substitute payer, and the determining, by the processor, a substitute payment amount of the substitute payer and a payment amount of a user based on the substitute payment instruction is specifically: determining the substitute payment amount of the substitute payer based on the received substitute payment amount of the substitute payer, and calculating the payment amount of the user based on the total payment amount and the substitute payment amount of the substitute payer.

Optionally, the substitute payment instruction includes a random allocation instruction. The determining, by the processor, a substitute payment amount of the substitute payer and a payment amount of a user based on the substitute payment instruction is specifically: randomly allocating the substitute payment amount of the substitute payer and the payment amount of the user based on the received random allocation instruction, to obtain a random allocation result of the total payment amount, and dividing the total payment amount based on the random allocation result, to determine the substitute payment amount of the substitute payer and the payment amount of the user.

This embodiment of the present invention provides a payment terminal. The payment terminal can divide the total payment amount, so that the at least two substitute payers each perform substitute payment of a part of the total payment amount, or the user and at least one substitute payer each perform substitute payment of a part of the total payment amount. In this way, a plurality of persons pay for a same order, and each substitute payer performs substitute payment of only a part of a total payment amount of the order, thereby reducing a substitute payment amount of the substitute payer, and increasing a bill transaction success rate.

An embodiment of the present invention provides a substitute payment server. As shown in FIG. 11, the substitute payment server includes a processor 10, a memory 11, a system bus 12, and a transceiver 13.

The memory 11 is configured to store a computer-executed instruction. The processor 10 is connected to the memory 11 by using the system bus 12. When the substitute payment server runs, the processor 10 executes the computer-executed instruction stored in the memory 11, so that the substitute payment server performs the payment method shown in FIG. 4A, FIG. 4B, and FIG. 4C, FIG. 8A, FIG. 8B, and FIG. 8C, or FIG. 9A and FIG. 9B. For a specific payment method, refer to the related description in the embodiment shown in FIG. 4A, FIG. 4B, and FIG. 4C, FIG. 8A, FIG. 8B, and FIG. 8C, or FIG. 9A and FIG. 9B, and details are not described herein again.

This embodiment further provides a storage medium. The storage medium may include the memory 11.

The processor 10 may be a central processing unit (English: central processing unit, CPU for short). Alternatively, the processor 10 may be another general-purpose processor, a digital signal processor (English: digital signal processor, DSP for short), an application-specific integrated circuit (English: application-specific integrated circuit, ASIC for short), a field-programmable gate array (English: field-programmable gate array, FPGA for short) or another programmable logic device, a discrete gate or a transistor logic device, a discrete hardware component, or the like. The general-purpose processor may be a microprocessor, or the processor may be any conventional processor or the like.

The memory 11 may include a volatile memory, for example, a random access memory RAM; or the memory 11 may include a non-volatile memory, for example, a read-only memory ROM, a flash memory, an HDD, or an SSD; or the memory 11 may include a combination of the foregoing memories.

The system bus 12 may include a data bus, a power bus, a control bus, a signal status bus, and the like. In this embodiment, for clarity of description, various buses are illustrated as the system bus 12 in FIG. 13.

The transceiver 13 may be specifically a transceiver on a substitute payment server. The transceiver may be a wireless transceiver. The processor 10 receives data from and sends data to another device, for example, a terminal, by using the transceiver 13.

In a specific implementation process, each step in the method procedure shown in FIG. 4A, FIG. 4B, and FIG. 4C, FIG. 8A, FIG. 8B, and FIG. 8C, or FIG. 9A and FIG. 9B may be implemented by the processor 10 in a hardware form by executing the computer-executed instruction that is in a software form and that is stored in the memory 11. To avoid repetition, details are not described herein again.

Specifically, when the substitute payment server provided in this embodiment of the present invention performs the payment method shown in FIG. 4A, FIG. 4B, and FIG. 4C or FIG. 8A, FIG. 8B, and FIG. 8C, the transceiver is configured to receive a substitute payment request message sent by a payment terminal, where the substitute payment request message includes information about at least two substitute payers and a substitute payment amount of each of the at least two substitute payers;

the processor is configured to generate a corresponding payment link based on the substitute payment amount, received by the transceiver, of each substitute payer; and

the transceiver is further configured to send the corresponding payment link to a corresponding substitute payment terminal based on information about each substitute payer, so that the corresponding substitute payment terminal pays a substitute payment amount of a corresponding substitute payer based on the corresponding payment link by using a payment gateway.

Further, the information about each substitute payer includes contact information of the corresponding substitute payer, and the sending, by the transceiver, the corresponding payment link to a corresponding substitute payment terminal based on information about each substitute payer is specifically: sending the corresponding payment link to the corresponding substitute payment terminal based on contact information of each substitute payer, where the corresponding substitute payment terminal runs an application program corresponding to the contact information of the corresponding substitute payer.

Further, the transceiver is further configured to: after sending the corresponding payment link to the corresponding substitute payment terminal based on the information about each substitute payer, receive a payment acknowledgment message sent by the payment gateway, where the payment acknowledgment message includes an identifier of a payer and a second order number.

The processor is further configured to: if determining that the identifier of the payer is the same as an identifier of one of the at least two substitute payers, and the second order number is the same as the first order number, determine that the substitute payer completes payment of a substitute payment amount of the substitute payer.

Further, the processor is further configured to: after determining that each of the at least two substitute payers completes payment, summarize substitute payment amounts of the at least two substitute payers, and generate a payment feedback message, where the payment feedback message is used to indicate that payment of a total payment amount corresponding to the first order number is completed.

The transceiver is further configured to send the payment feedback message to a payee terminal based on the merchant information.

Further, the substitute payment request message further includes a payment amount of the user and an identifier of the user. The processor is further configured to: after determining that each of the at least two substitute payers and the user completes payment, summarize substitute payment amounts of the at least two substitute payers and the payment amount of the user, and generate a payment feedback message, where the payment feedback message is used to indicate that payment of a total payment amount corresponding to the first order number is completed.

The transceiver is further configured to send the payment feedback message to a payee terminal based on the merchant information.

Optionally, when the substitute payment server provided in this embodiment of the present invention performs the payment method shown in FIG. 9A and FIG. 9B, the transceiver is configured to receive a substitute payment request message sent by a payment terminal, where the substitute payment request message includes information about a substitute payer and a substitute payment amount of the substitute payer, and the substitute payment amount of the substitute payer is less than a total payment amount;

the processor is configured to generate a payment link based on the substitute payment amount of the substitute payer; and

the transceiver is further configured to send the payment link to a corresponding substitute payment terminal based on the information about the substitute payer, so that the substitute payment terminal pays the substitute payment amount of the substitute payer based on the payment link by using a payment gateway.

Further, the information about the substitute payer includes contact information of the substitute payer, and the sending, by the transceiver, the payment link to a corresponding substitute payment terminal based on the information about the substitute payer is specifically: sending the payment link to the corresponding substitute payment terminal based on the contact information of the substitute payer, where the substitute payment terminal runs an application program corresponding to the contact information of the substitute payer.

Further, the transceiver is further configured to: after sending the payment link to the corresponding substitute payment terminal based on the information about the substitute payer, receive a payment acknowledgment message sent by the payment gateway, where the payment acknowledgment message includes an identifier of a payer and a second order number.

The processor is further configured to: if determining that the identifier of the payer is the same as the identifier of the substitute payer, and the second order number is the same as the first order number, determine that the substitute payer completes payment of the substitute payment amount of the substitute payer.

Further, the substitute payment request message further includes a payment amount of the user and an identifier of the user. The processor is further configured to: after determining that each of the substitute payer and the user completes payment, summarize the substitute payment amount of the substitute payer and the payment amount of the user, and generate a payment feedback message, where the payment feedback message is used to indicate that payment of the total payment amount corresponding to the first order number is completed.

The transceiver is further configured to send the payment feedback message to a payee terminal based on the merchant information.

This embodiment of the present invention provides a substitute payment server. The substitute payment server can receive the substitute payment request message sent by the payment terminal, generate, based on the substitute payment amount of the substitute payer that is carried in the substitute payment request message, the payment link corresponding to the substitute payment amount of the substitute payer, and send the payment link to the corresponding substitute payment terminal, so that the substitute payer pays the substitute payment amount of the substitute payer. In this way, a plurality of substitute payers can perform substitute payment for a same order, or the user and at least one substitute payer pay for a same order, and each substitute payer performs substitute payment of only a part of a total payment amount of the order, thereby reducing a substitute payment amount of the substitute payer, and increasing a bill transaction success rate.

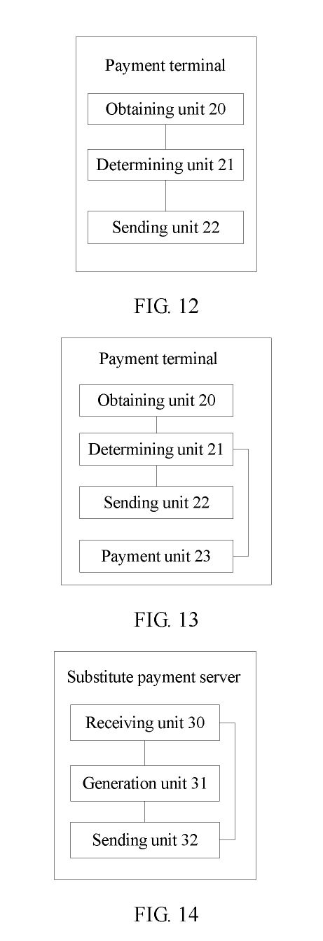

As shown in FIG. 12, an embodiment of the present invention provides a payment terminal. The payment terminal is configured to perform steps that are in the payment method and that are performed by a payment terminal. For example, the payment terminal may include:

an obtaining unit 20, configured to obtain order information, where the order information includes at least a total payment amount;

a determining unit 21, configured to receive a substitute payment instruction, and determine information about at least two substitute payers and a substitute payment amount of each of the at least two substitute payers based on the substitute payment instruction, where a sum of substitute payment amounts of the at least two substitute payers is less than or equal to the total payment amount; and

a sending unit 22, configured to send a substitute payment request message to a substitute payment server, where the substitute payment request message includes information about each substitute payer and the substitute payment amount of each substitute payer that are determined by the determining unit 21, and the substitute payment request message is used to request the substitute payment server to generate a payment link corresponding to the substitute payment amount of each substitute payer and send, based on the information about each substitute payer, the payment link corresponding to the substitute payment amount of each substitute payer to a corresponding substitute payment terminal.

Optionally, the substitute payment instruction includes a substitute payment triggering instruction and a selection instruction, and the information about the at least two substitute payers includes contact information of each substitute payer; and

the determining unit 20 is specifically configured to read and display, based on the substitute payment triggering instruction, a contact list stored on the payment terminal, and determine, based on the selection instruction, contact information of the at least two substitute payers that are selected by a user from the contact list.

Optionally, the substitute payment instruction includes the substitute payment amount of each substitute payer, and the determining unit 21 is specifically configured to determine the substitute payment amount of each substitute payer based on the received substitute payment amount of each substitute payer.

Optionally, the substitute payment instruction includes a random allocation instruction. The determining unit 21 is specifically configured to determine a quantity of the at least two substitute payers based on the random allocation instruction that is input by the user; randomly allocate the substitute payment amount of each substitute payer based on the total payment amount and the quantity of the at least two substitute payers, to obtain a random allocation result of the total payment amount; and divide the total payment amount based on the random allocation result, to determine the substitute payment amount of each substitute payer.

Optionally, the order information and the substitute payment request message further include a first order number and merchant information.

The information about the at least two substitute payers further includes an identifier of each substitute payer.

Optionally, with reference to FIG. 12, as shown in FIG. 13, the payment terminal further includes a payment unit 23.

The determining unit 21 is further configured to: after determining the substitute payment amount of each of the at least two substitute payers, calculate a payment amount of the user based on the total payment amount and the sum of the substitute payment amounts of the at least two substitute payers.

The payment unit 23 is configured to pay the payment amount of the user by using a payment gateway.

The substitute payment request message further includes the payment amount of the user and an identifier of the user.

This embodiment of the present invention provides a payment terminal. The payment terminal may determine the information about the at least two substitute payers, and divide the total payment amount to determine the substitute payment amount of each of the at least two substitute payers. The information about each substitute payer and the substitute payment amount of each substitute payer are carried in the substitute payment request message and sent to the substitute payment server by the payment terminal. The substitute payment server generates the payment link corresponding to the substitute payment amount of each substitute payer, and sends each payment link to the corresponding substitute payment terminal, so that the at least two substitute payers pay the substitute payment amounts of the at least two substitute payers. In this way, the at least two substitute payers can perform substitute payment for a same order, and each substitute payer needs to perform substitute payment of only a part of a total payment amount of the order, thereby reducing a substitute payment amount of the substitute payer, and increasing a bill transaction success rate.

As shown in FIG. 14, an embodiment of the present invention provides a substitute payment server, including a receiving unit 30, a generation unit 31, and a sending unit 32.

The receiving unit 30 is configured to receive a substitute payment request message sent by a payment terminal, where the substitute payment request message includes information about at least two substitute payers and a substitute payment amount of each of the at least two substitute payers.

The generation unit 31 is configured to generate a corresponding payment link based on the substitute payment amount, received by the receiving unit 30, of each substitute payer.

The sending unit 32 is configured to send the corresponding payment link to a corresponding substitute payment terminal based on information that is received by the receiving unit 30 and that is about each substitute payer, so that the corresponding substitute payment terminal pays a substitute payment amount of a corresponding substitute payer based on the corresponding payment link by using a payment gateway.

Optionally, the information about each substitute payer includes contact information of the corresponding substitute payer.

The sending unit 32 is specifically configured to send the corresponding payment link to the corresponding substitute payment terminal based on contact information of each substitute payer, where the corresponding substitute payment terminal runs an application program corresponding to the contact information of the corresponding substitute payer.

Optionally, the substitute payment request message further includes a first order number and merchant information.

The information about each substitute payer further includes an identifier of the corresponding substitute payer.

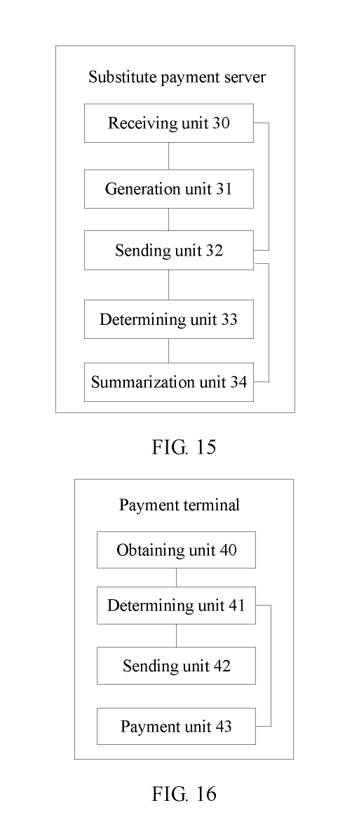

Optionally, with reference to FIG. 14, as shown in FIG. 15, the substitute payment server further includes a determining unit 33.

The receiving unit 30 is further configured to: after the sending unit 32 sends the corresponding payment link to the corresponding substitute payment terminal based on the information about each substitute payer, receive a payment acknowledgment message sent by the payment gateway, where the payment acknowledgment message includes an identifier of a payer and a second order number.

The determining unit 33 is configured to: if determining that the identifier of the payer is the same as an identifier of one of the at least two substitute payers, and the second order number is the same as the first order number, determine that the substitute payer completes payment of a substitute payment amount of the substitute payer.

Optionally, as shown in FIG. 15, the substitute payment server further includes a summarization unit 34.

The summarization unit 34 is configured to: after the determining unit 33 determines that each of the at least two substitute payers completes payment, summarize substitute payment amounts of the at least two substitute payers, and generate a payment feedback message, where the payment feedback message is used to indicate that payment of a total payment amount corresponding to the first order number is completed.

The sending unit 32 is further configured to send the payment feedback message to a payee terminal based on the merchant information.

Optionally, the substitute payment server further includes a summarization unit 34. The substitute payment request message further includes a payment amount of the user and an identifier of the user. The summarization unit 34 is configured to: after the determining unit 33 determines that each of the at least two substitute payers and the user completes payment, summarize substitute payment amounts of the at least two substitute payers and the payment amount of the user, and generate a payment feedback message, where the payment feedback message is used to indicate that payment of a total payment amount corresponding to the first order number is completed.

The sending unit 32 is further configured to send the payment feedback message to a payee terminal based on the merchant information.

This embodiment of the present invention provides a substitute payment server. The substitute payment server can receive the substitute payment request message sent by the payment terminal, generate the corresponding payment link based on the substitute payment amount of each of the at least two substitute payers that is carried in the substitute payment request message, and send the payment link to the substitute payment terminal, so that the substitute payer pays the substitute payment amount of the substitute payer. In this way, the at least two substitute payers can perform substitute payment for a same order, and each substitute payer needs to perform substitute payment of only a part of a total payment amount of the order, thereby reducing a substitute payment amount of the substitute payer, and increasing a bill transaction success rate.

As shown in FIG. 16, an embodiment of the present invention provides a payment terminal, including:

an obtaining unit 40, configured to obtain order information, where the order information includes at least a total payment amount;

a determining unit 41, configured to receive a substitute payment instruction, and determine information about a substitute payer, a substitute payment amount of the substitute payer, and a payment amount of a user based on the substitute payment instruction, where the substitute payment amount of the substitute payer is less than the total payment amount;

a sending unit 42, configured to send a substitute payment request message to a substitute payment server, where the substitute payment request message includes the information about the substitute payer and the substitute payment amount of the substitute payer, and the substitute payment request message is used to request the substitute payment server to generate a payment link corresponding to the substitute payment amount of the substitute payer and send the payment link to a corresponding substitute payment terminal based on the information about the substitute payer; and

a payment unit 43, configured to pay the payment amount of the user by using a payment gateway.

Optionally, the substitute payment instruction includes a substitute payment triggering instruction and a selection instruction, and the information about the substitute payer includes contact information of the substitute payer.

The determining unit 41 is specifically configured to read and display, based on the substitute payment triggering instruction, a contact list stored on the payment terminal, and determine, based on the selection instruction, the contact information of the substitute payer that is selected by the user from the contact list.

Optionally, the substitute payment instruction includes the substitute payment amount of the substitute payer, and the determining unit 41 is specifically configured to determine the substitute payment amount of the substitute payer based on the received substitute payment amount of the substitute payer, and calculate the payment amount of the user based on the total payment amount and the substitute payment amount of the substitute payer.

Optionally, the substitute payment instruction includes a random allocation instruction. The determining unit 41 is specifically configured to randomly allocate the substitute payment amount of the substitute payer and the payment amount of the user based on the received random allocation instruction, to obtain a random allocation result of the total payment amount, and determine the substitute payment amount of the substitute payer and the payment amount of the user based on the random allocation result.

Optionally, the order information obtained by the obtaining unit 40 further includes a first order number and merchant information.

The substitute payment request message sent by the sending unit 42 further includes the first order number, the merchant information, the payment amount of the user, and an identifier of the user.

The information that is determined by the determining unit 41 and that is about the substitute payer further includes an identifier of the substitute payer.

This embodiment of the present invention provides a payment terminal. The payment terminal can divide the total payment amount, so that the user and the substitute payer each perform substitute payment of a part of the total payment amount. In this way, a plurality of persons pay for a same order, and the substitute payer performs substitute payment of only a part of a total payment amount of the order, thereby reducing the substitute payment amount of the substitute payer, and increasing a bill transaction success rate.

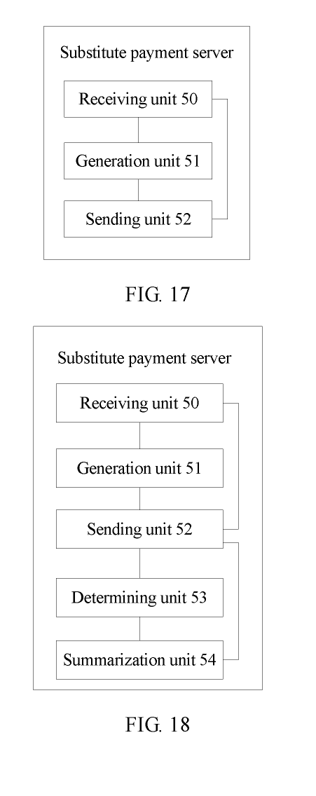

As shown in FIG. 17, an embodiment of the present invention provides a substitute payment server, including:

a receiving unit 50, configured to receive a substitute payment request message sent by a payment terminal, where the substitute payment request message includes information about a substitute payer and a substitute payment amount of the substitute payer, and the substitute payment amount of the substitute payer is less than a total payment amount;

a generation unit 51, configured to generate a payment link based on the substitute payment amount of the substitute payer; and

a sending unit 52, configured to send the payment link to a corresponding substitute payment terminal based on the information about the substitute payer, so that the substitute payment terminal pays the substitute payment amount of the substitute payer based on the payment link by using a payment gateway.

Optionally, the information that is received by the receiving unit 50 and that is about the substitute payer includes contact information of the substitute payer, and the sending unit 52 is specifically configured to send the payment link to the corresponding substitute payment terminal based on the contact information of the substitute payer, where the substitute payment terminal runs an application program corresponding to the contact information of the substitute payer.

Optionally, the substitute payment request message received by the receiving unit 50 further includes a first order number and merchant information.

The information about the substitute payer further includes an identifier of the substitute payer.

Optionally, with reference to FIG. 17, as shown in FIG. 18, the substitute payment server further includes a determining unit 53. The receiving unit 50 is further configured to: after the sending unit 52 sends a notification message to the substitute payment terminal based on the information about the substitute payer, receive a payment acknowledgment message sent by the payment gateway, where the payment acknowledgment message includes an identifier of a payer and a second order number.

The determining unit 53 is configured to: if determining that the identifier of the payer is the same as the identifier of the substitute payer, and the second order number is the same as the first order number, determine, by the substitute payment server, that the substitute payer completes payment of the substitute payment amount of the substitute payer.

Optionally, the substitute payment request message received by the receiving unit 50 further includes a payment amount of the user and an identifier of the user. As shown in FIG. 18, the substitute payment server further includes a summarization unit 54. The summarization unit 54 is configured to: after the determining unit 53 determines that each of the substitute payer and the user completes payment, summarize the substitute payment amount of the substitute payer and the payment amount of the user, and generate a payment feedback message, where the payment feedback message is used to indicate that payment of the total payment amount corresponding to the first order number is completed.

The sending unit 52 is further configured to send the payment feedback message to a payee terminal based on the merchant information.

This embodiment of the present invention provides a substitute payment server. The substitute payment server can receive the substitute payment request message sent by the payment terminal, generate the corresponding payment link based on the substitute payment amount of the substitute payer that is carried in the substitute payment request message, and send the payment link to the corresponding substitute payment terminal, so that the substitute payer pays the substitute payment amount of the substitute payer. In this way, the user and the substitute payer can perform substitute payment for a same order, and the substitute payer needs to perform substitute payment of only a part of a total payment amount of the order, thereby reducing the substitute payment amount of the substitute payer, and increasing a bill transaction success rate.

As shown in FIG. 1, an embodiment of the present invention provides a payment system, including: the payment terminal shown in FIG. 10, the substitute payment server shown in FIG. 11, a substitute payment terminal, a payment gateway, and a payee terminal.

Alternatively, the payment system includes: the payment terminal shown in FIG. 12 or FIG. 13, the substitute payment server shown in FIG. 14 or FIG. 15, a substitute payment terminal, a payment gateway, and a payee terminal.

Alternatively, the payment system includes: the payment terminal shown in FIG. 16, the substitute payment server shown in FIG. 17 or FIG. 18, a substitute payment terminal, a payment gateway, and a payee terminal.

The payment terminal and substitute payment server in the payment system provided in this embodiment of the present invention can perform the payment method shown in FIG. 4A, FIG. 4B, and FIG. 4C, FIG. 8A, FIG. 8B, and FIG. 8C, or FIG. 9A and FIG. 9B. For a specific payment method, refer to the related description in the embodiment shown in FIG. 4A, FIG. 4B, and FIG. 4C, FIG. 8A, FIG. 8B, and FIG. 8C, or FIG. 9A and FIG. 9B, and details are not described herein again.

Based on the payment system provided in this embodiment of the present invention, a plurality of persons can pay for a same order, and each substitute payer needs to perform substitute payment of only a part of a total payment amount of the order, thereby reducing a substitute payment amount of the substitute payer, and increasing a bill transaction success rate.

It may be clearly understood by a person skilled in the art that, for the purpose of convenient and brief description, division of the foregoing function modules is used as an example for illustration. In actual application, the foregoing functions can be allocated to different function modules and implemented according to a requirement, that is, an internal structure of an apparatus is divided into different function modules to implement all or some of the functions described above. For a detailed working process of the foregoing system, apparatus, and unit, refer to a corresponding process in the foregoing method embodiments, and details are not described herein.

In the several embodiments provided in this application, it should be understood that the disclosed system, apparatus, and method may be implemented in other manners. For example, the described apparatus embodiment is only an example. For example, the module or unit division is only logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The foregoing integrated unit may be implemented in a form of a software functional unit.

When the integrated unit is implemented in the form of a software functional unit and sold or used as an independent product, the integrated unit may be stored in a computer-readable storage medium. Based on such an understanding, all of the technical solutions or the part of the technical solutions may be implemented in a form of a software product. The computer software product is stored in a storage medium, and includes several instructions for instructing a computer device (which may be a personal computer, a server, a network device, or the like) or a processor to perform all or some of the steps of the methods described in the embodiments of the present invention. The foregoing storage medium is a non-transitory (English: non-transitory) medium, and includes: any medium that can store program code, such as a flash memory, a removable hard disk, a read-only memory, a random access memory, a magnetic disk, or an optical disc.

The descriptions are only specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A payment method, comprising:
obtaining, by a payment terminal, order information, the order information comprising at least a total payment amount;
receiving, by the payment terminal, a substitute payment instruction;
determining, by the payment terminal, information about at least two substitute payers and a substitute payment amount of each of the at least two substitute payers based on the substitute payment instruction, a sum of substitute payment amounts of the at least two substitute payers being less than or equal to the total payment amount; and
sending, by the payment terminal, a substitute payment request message to a substitute payment server, the substitute payment request message comprising information about each substitute payer and the substitute payment amount of each substitute payer, and the substitute payment request message requesting the substitute payment server to generate a payment link corresponding to the substitute payment amount of each substitute payer and send, based on the information about each substitute payer, the payment link corresponding to the substitute payment amount of each substitute payer to a substitute payment terminal corresponding to each substitute payer.

2. The method of claim 1, wherein the substitute payment instruction comprises a substitute payment triggering instruction and a selection instruction, the information about the at least two substitute payers comprising contact information of each substitute payer, and determining the information about the at least two substitute payers based on the substitute payment instruction comprising:
reading and displaying, by the payment terminal based on the substitute payment triggering instruction, a contact list stored on the payment terminal; and
determining, by the payment terminal based on the selection instruction, contact information of the at least two substitute payers selected by a user from the contact list.

3. The method of claim 1, wherein the substitute payment instruction comprises the substitute payment amount of each substitute payer, and determining the substitute payment amount of each of the at least two substitute payers based on the substitute payment instruction comprising determining, by the payment terminal, the substitute payment amount of each substitute payer based on the received substitute payment amount of each substitute payer.

4. The method of claim 1, wherein the substitute payment instruction comprises a random allocation instruction, and determining the substitute payment amount of each of the at least two substitute payers based on the substitute payment instruction comprising:
determining, by the payment terminal, a quantity of the at least two substitute payers based on the received random allocation instruction;
randomly allocating, by the payment terminal, the substitute payment amount of each substitute payer based on the total payment amount and the quantity of the at least two substitute payers to obtain a random allocation result of the total payment amount; and
dividing, by the payment terminal, the total payment amount based on the random allocation result to determine the substitute payment amount of each substitute payer.

5. The method of claim 1, wherein after determining the substitute payment amount of each of the at least two substitute payers based on the substitute payment instruction, the method further comprises:
calculating, by the payment terminal, a payment amount of a user based on the total payment amount and the sum of the substitute payment amounts of the at least two substitute payers; and
paying, by the payment terminal, the payment amount of the user using a payment gateway, the substitute payment request message further comprising the payment amount of the user and an identifier of the user.

6.-10. (canceled)

11. A payment method, comprising:
obtaining, by a payment terminal, order information, the order information comprises at least a total payment amount;
receiving, by the payment terminal, a substitute payment instruction;
determining, by the payment terminal, information about a substitute payer, a substitute payment amount of the substitute payer, and a payment amount of a user based on the substitute payment instruction, the substitute payment amount of the substitute payer being less than the total payment amount;
sending, by the payment terminal, a substitute payment request message to a substitute payment server, the substitute payment request message comprising the information about the substitute payer and the substitute payment amount of the substitute payer, and the substitute payment request message requesting the substitute payment server to generate a payment link corresponding to the substitute payment amount of the substitute payer and send the payment link to a corresponding substitute payment terminal based on the information about the substitute payer; and
paying, by the payment terminal, the payment amount of the user using a payment gateway.

12. The method of claim 11, wherein the substitute payment instruction comprises the substitute payment amount of the substitute payer, and determining the substitute payment amount of the substitute payer and the payment amount of the user based on the substitute payment instruction comprising:
determining, by the payment terminal, the substitute payment amount of the substitute payer based on the received substitute payment amount of the substitute payer; and
calculating, by the payment terminal, the payment amount of the user based on the total payment amount and the substitute payment amount of the substitute payer.

13.-16. (canceled)

17. A payment terminal, comprising:
an input device configured to receive a substitute payment instruction; and
a processor coupled to input device and configured to:
obtain order information;
determine information about at least two substitute payers and a substitute payment amount of each of the at least two substitute payers based on the substitute payment instruction received by the input device, the order information comprising at least a total payment amount, and a sum of substitute payment amounts of the at least two substitute payers is less than or equal to the total payment amount; and
a radio frequency (RF) circuit configured coupled to the processor and configured to send a substitute payment request message to a substitute payment server, the substitute payment request message comprising information about each substitute payer and the substitute payment amount of each substitute payer determined by the processor, and the substitute payment request message requesting the substitute payment server to generate a payment link corresponding to the substitute payment amount of each substitute payer and send, based on the information about each substitute payer, the payment link corresponding to the substitute payment amount of each substitute payer to a corresponding substitute payment terminal.

18. The payment terminal of claim 17, wherein the substitute payment instruction comprises a substitute payment triggering instruction and a selection instruction, the information about the at least two substitute payers comprising contact information of each substitute payer, and in a manner of determining, the information about the at least two substitute payers based on the substitute payment instruction, the processor being further configured to:
read and display, based on the substitute payment triggering instruction, a contact list stored on the payment terminal; and
determine, based on the selection instruction, contact information of the at least two substitute payers selected by a user from the contact list.

19. The payment terminal of claim 17, wherein the substitute payment instruction comprises the substitute payment amount of each substitute payer, and in a manner of determining the substitute payment amount of each substitute payer based on the substitute payment instruction, the processor being further configured to determine the substitute payment amount of each substitute payer based on the received substitute payment amount of each substitute payer.

20. The payment terminal of claim 17, wherein the substitute payment instruction comprises a random allocation instruction, and in a manner of determining the substitute payment amount of each substitute payer based on the substitute payment instruction determining, the processor being further configured to:
determining a quantity of the at least two substitute payers based on the received random allocation instruction;
randomly allocate the substitute payment amount of each substitute payer based on the total payment amount and the quantity of the at least two substitute payers to obtain a random allocation result of the total payment amount; and
determine the substitute payment amount of each substitute payer based on the random allocation result.

21.-25. (canceled)

26. A payment terminal, comprising;
an input device configured to receive a substitute payment instruction;
a processor couple to the input device and configured to:
obtain order information;
determine information about a substitute payer, a substitute payment amount of the substitute payer, and a payment amount of a user based on the substitute payment instruction; and
pay the payment amount of the user using a payment gateway, the order information comprising at least a total payment amount, and the substitute payment amount of the substitute payer being less than the total payment amount; and
a radio frequency (RF) circuit coupled to the processor and configured to send a substitute payment request message to a substitute payment server, the substitute payment request message comprising the information about the substitute payer and the substitute payment amount of the substitute payer, and the substitute payment request message requesting the substitute payment server to generate a payment link corresponding to the substitute payment amount of the substitute payer and send the payment link to a corresponding substitute payment terminal based on the information about the substitute payer.

27. The payment terminal of claim 26, wherein the substitute payment instruction comprises the substitute payment amount of the substitute payer, and in a manner of determining the substitute payment amount of the substitute payer and the payment amount of the user based on the substitute payment instruction, the processor being further configured to:
determine the substitute payment amount of the substitute payer based on the received substitute payment amount of the substitute payer; and
calculate the payment amount of the user based on the total payment amount and the substitute payment amount of the substitute payer.

28.-32. (canceled)

33. The method of claim 1, wherein the payment terminal is a point of sales (POS) terminal.

34. The method of claim 1, wherein the payment terminal is a wearable device.

35. The method of claim 1, wherein the payment terminal is a mobile phone.

36. The method of claim 1, wherein the payment terminal is a tablet computer.

37. The method of claim 1, wherein the payment terminal is an in-vehicle computer.

38. The method of claim 2, wherein the contact list is at least one address books stored on the payment terminal.

39. The payment terminal of claim 18, wherein the contact list is at least one address books stored on the payment terminal.
